(19) United States
(12) Patent Application Publication
(10) Pub. No.: US 2017/0262867 A1
(43) Pub. Date: Sep. 14, 2017

(54) SYSTEM, APPARATUS AND METHOD FOR AUTOMATICALLY GENERATING A PROPOSED STATE

(71) Applicant: Kenji HAGIWARA, Edgewater, NJ (US)

(72) Inventor: Kenji HAGIWARA, Edgewater, NJ (US)

(73) Assignee: RICOH COMPANY, LTD., Tokyo (JP)

(21) Appl. No.: 15/064,433

(22) Filed: Mar. 8, 2016

(51) Int. Cl. G06Q 30/02; H04N 1/00; G06F 3/0482; H04L 12/24; G06F 3/0484

(52) U.S. Cl. CPC G06Q 30/0201; H04L 41/22; G06F 3/04842; G06F 3/0482; H04N 1/00007; H04N 2201/0094

(57) ABSTRACT

Systems, apparatuses, application software and methodologies are configured for generating automatically a proposed state (e.g., a proposed fleet of devices), for an enterprise or another organization, based on user-specified auto-creation options. Thus, obtaining a proposed state analysis becomes a manageable task, based on a current state analysis, or based on another registered proposed state.

### TECHNICAL FIELD

This disclosure relates to systems, apparatuses, methodologies, application software and other tools for generating a proposed state, and more specifically, such tools including provisions to generate a proposed state based on a current state or a current state analysis of a current fleet of devices, or based on another registered proposed state, and user-specified auto-creation options.

### BACKGROUND

In the current information age, information technology (IT) tools are extensively used in enterprises and other organizations in order to facilitate communication and processing of information, documents, data, etc. Indeed, it is now rare to find a workflow in an enterprise that does not employ IT tools. The number of IT assets [such as software, computers, printers, scanners, multi-function devices (MFDs), other network-connected or standalone devices] is generally increasing and, as a result, managing IT assets to meet enterprise needs is becoming a daunting task.

One approach for a vendor to make an educated and intriguing sales pitch to a customer or prospective customer is to present a proposal along with an analysis of the current IT expenditures of the customer or prospective customer. For example, a customer may wish to know, and a current state analysis may be prepared to show, total cost of ownership, or expected expenditures (such as for consumables) for devices [e.g., printers, scanners, facsimile devices, multi-function peripherals (MFP), etc.] for each period of one or more months, a year, 3 years, etc., output volumes, etc. Accordingly, the vendor typically attempts to determine the current IT assets of the customer or prospective customer and then collate information such as, but not limited to, acquisition type (i.e. lease/purchase), acquisition cost, depreciation of product, service cost, and in the case of printing products/services, consumables (e.g., paper, ink, toner, etc.) usage or cost, output, etc. Further, the vendor may analyze the needs of the customer or prospective customer in order to be able to offer a package of products and/or services that is attractive to the customer or prospective customer.

However, since a virtually infinite number of candidate devices are typically available in the market for consideration, there exists a need for an improved approach for compiling and presenting a proposed fleet of devices for consideration.

### SUMMARY

Various tools (e.g., systems, apparatuses, methodologies, application software, computer program products, etc.) can be configured to include any combination of various aspects and features described herein, to perform a proposed state analysis of a proposed fleet of devices. Such tools can be employed by sales or marketing personnel, as well as by a customer, in a case of new sale, as well as in the instance of contract renewal, to obtain a proposed state analysis of a proposed fleet of devices for the customer.

In an aspect, such a tool is configured to generate automatically a proposed state analysis upon the user selecting one or more auto-creation options, and based on, and compared to, a current state analysis of the current fleet of devices employed by the customer or a customer site, so that the customer can more readily understand the difference between the proposed state and the current state.

Such tool provides a user interface (UI) to permit a user to select auto-creation options. The user interface may additionally permit the user to manually select and revise a fleet of devices, and may include UI parts to add devices to, modify devices in, and remove devices from the fleet of devices and register such fleet in a proposed state. The auto-creation process of a proposed state may be based on a current state (e.g., current fleet of output or image forming devices in an enterprise or enterprise site) or a selected current state analysis of the current fleet, or based on a previously generated or registered proposed state (e.g. a proposed fleet of image forming or output devices).

The tool also includes a proposed state auto-creation module to perform a process to automatically apply the user-selected auto-creation options to modify the user-specified fleet of devices and generate a proposed state analysis of the modified fleet of devices.

For example, the automatic generation of a proposed state may include one or more of the following:
replace printers in the specified fleet of devices to new NFP (multi-function peripheral) devices which have more capability, and such replacement may include replacing multiple printers with one NFP device;
replace color output devices with mono devices (e.g., to reduce cost);
replace A3-format devices to A4-format devices (e.g., to reduce cost);
replace devices manufactured by a manufacturer other than a specific vendor, with replacement devices manufactured by the specific vendor;
replace devices manufactured by a specific vendor, with replacement devices manufactured by manufacturers other than the specific vendor;
replace old devices with new devices of similar capabilities or functionalities;
replace non-eco devices to eco devices;
etc.

Generally, the automatic replacement entails matching a replacement target in the specified fleet with a replacement device that has similar capabilities (e.g., output, duplex/simplex, N-to-1, color/mono, format/size, etc.) or functionalities (e.g., print, fax, copy, scan, scan-to-file, scan-to-email, etc.), as much as possible.

### BRIEF DESCRIPTION OF THE DRAWINGS

The aforementioned and other aspects, features and advantages can be more readily understood from the following detailed description with reference to the accompanying drawings wherein:

FIG. 1A shows a block diagram of a system within which a device marketing or fleet management application operates to generate a proposed state (e.g., proposed fleet of devices) for an enterprise or enterprise site, and/or generate a proposed state analysis, according to an exemplary embodiment;

FIG. 1B shows a block diagram of a system within which a device marketing or fleet management application operates to generate a proposed state (e.g., proposed fleet of devices) for an enterprise or enterprise site, and/or generate a proposed state analysis, according to another exemplary embodiment;

FIG. 2 shows a block diagram of an example of a computing device that can be configured by software to operate as a server;

FIG. 3 shows a block diagram of an example of a terminal or terminal apparatus;

FIG. 4 shows a block diagram of an example of a multi-function device;

FIG. 5 shows a flow chart of a method, according to an exemplary embodiment, which can be performed in any of the systems shown in FIGS. 1A and 1B;

FIGS. 6A-6K show respective examples of user interface screens provided on a terminal apparatus, according to an exemplary embodiment;

FIG. 7 shows a flow chart of a method, according to an exemplary embodiment, which can be performed in any of the systems shown in FIGS. 1A and 1B;

FIGS. 8A-8K show respective examples of user interface screens which can be provided by a device marketing or fleet management application, according to an exemplary embodiment;

FIG. 9 shows a flow chart of a method, according to an exemplary embodiment, which can be performed in any of the systems shown in FIGS. 1 and 2;

FIG. 10 shows a user interface screen which can be provided by a device marketing or fleet management application, according to an exemplary embodiment.

### DETAILED DESCRIPTION

In describing preferred embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

Various tools to facilitate fleet analysis, device marketing or fleet management are discussed herein, with reference to examples in which a software application has a document management function and/or a document editor function. It should be appreciated by those skilled in the art that any one or more of such tools may be embedded in the application and/or in any of various other ways, and thus while various examples are discussed herein, the inventive aspects of this disclosure are not limited to such examples described herein.

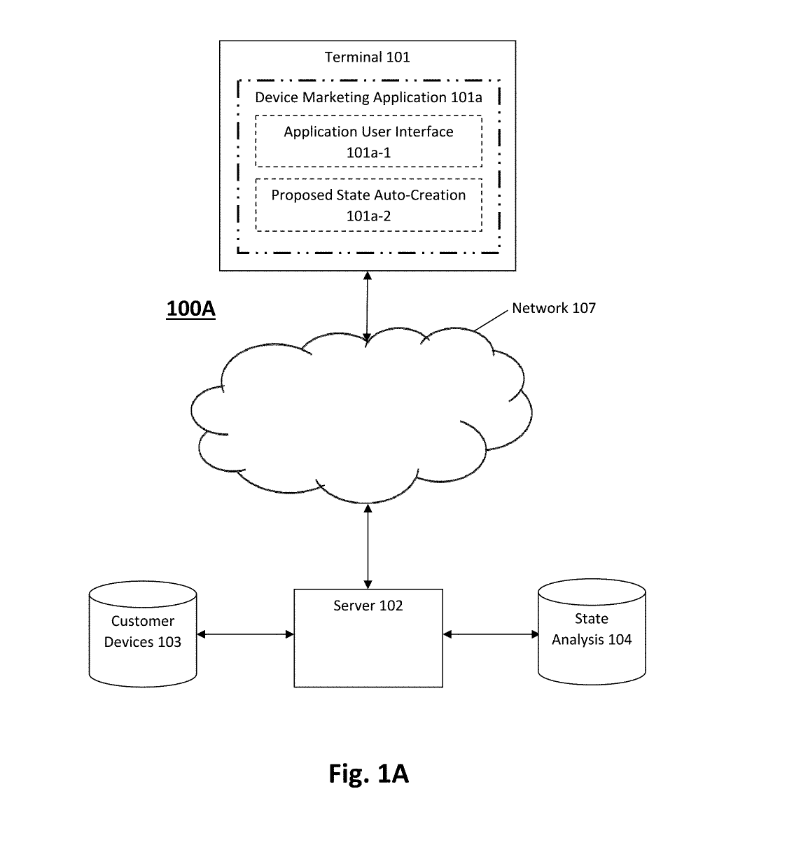

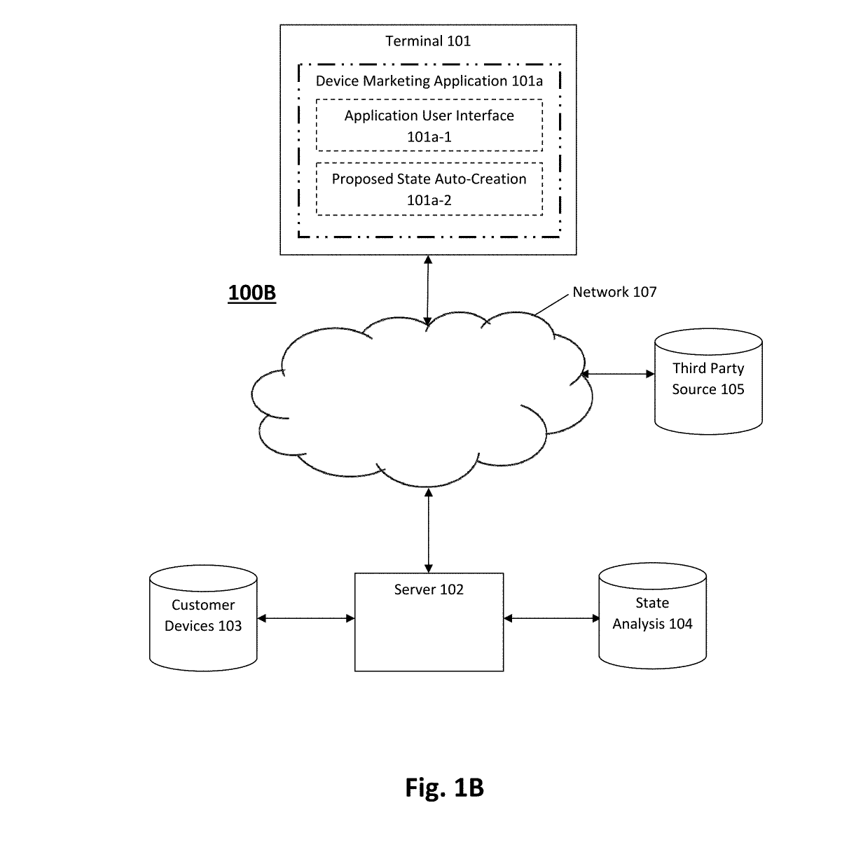

FIG. 1A shows schematically a system 100A that includes a terminal 101 and a server 102 which are interconnected through network 106. Although only one terminal is shown in FIG. 1A, it should be understood that the system 100A can include a plurality of terminal devices (which can have similar or different configurations).

The terminal 101 can be any computing device, including but not limited to a personal, notebook or workstation computer, a PDA (personal digital assistant), a mobile phone or handset, another information terminal, etc., that can communicate with other devices through the network 107. The terminal 101 is further described infra with reference to FIG. 3.

Device marketing (or fleet management or analysis) application 101a may be provided on or to the terminal 101 to display a user interface through which a user can request an analysis of a fleet of devices. Such application may be a native program installed on the terminal 101, or may be provided from an external source as an application and/or as part of a platform or service (e.g., software as a service, i.e. SaaS), or may be provided as a web page.

Further, the device marking application 101a is configured to perform analysis and calculations with regards to a fleet (or set) of one or more specified devices. Such analysis may be performed on an existing set of devices (e.g., a current fleet of devices employed by a particular organization) or a proposed set of devices (e.g., a list of devices recommended to a particular organization for purchase, lease, etc.). Such analysis may be performed for the purpose of determining a set of devices that can meet the needs of a customer, in an optimal manner preferably.

When, for example, a new customer seeks a proposal for updating its fleet of output devices, a vendor would typically like to know what devices are currently employed by the customer in the customer's fleet. Such information may be sent to the vendor in various forms. For example, the customer may send a list of the devices constituting the current fleet to the vendor in an electronic format (e.g., spreadsheet, e-mail, etc.) or by paper (e.g., handwriting, typed, etc.). In another example, the customer may simply tell the vendor (e.g., meetings, telephone conference, etc.) what devices the specific customer currently possesses. After receiving information regarding the current devices from the specific customer, the vendor can utilize (that is, as a user of) the device marketing (or fleet analysis or management) application 101a to create a current state analysis which includes the list of devices currently possessed by the customer. It should be noted that the analysis may be performed for each device individually and/or the entirety of the devices at a site.

In such example, a copy of the current state analysis data can be employed as an initial starting point for a proposed state. When the user has specified that auto-creation of a proposed state is desired, the application user interface 101a-1 presents one or more auto-creation options for selection by the vendor. The process of determining replacement targets and replacement devices may include determining (i) target devices that are to be replaced based on target device criteria that are set in the user-selected auto-creation options and (ii) replacement devices which fulfill replacement criteria which are specified in the selected auto-creation options and (b) matching criteria (e.g., recommended device output volume, mono-color-capability, output type and capability, device type, etc.) which are also set in the selected auto-creation options

The proposed state auto-creation module 101a-2 receives one or more of the auto-creation options selected by the user from the application UI 101a-1 and revises the proposed state by replacing target devices in the proposed state with replacement devices that match criteria corresponding to the user-selected auto-creation options. After the auto-creation module 101a-2 has finished modifying the proposed state, the auto-creation module 101a-2 generates a proposed state analysis of the proposed fleet of devices.

In an exemplary embodiment, the one or more auto-creation options may include a device-type replacement option in which one or more devices in the proposed state which are of a certain device type, are replaced with devices that are of another device type. For example, the auto-creation options may include a printer-to-MFP option in which the auto-creation module 101a-2 (i) selects one or more devices in the current state analysis that are printers and (ii) replaces the selected devices with MFPs. In addition, the MFPs that are selected to replace the printers may match the printers in terms of recommended device output volume and output type and capability. In another similar example, the auto-creation options may include an MFP-to-printer option in which the auto-creation module 101a-2 (i) selects one or more devices in the proposed state that are MFPs and (ii) replaces the selected devices with printers. Likewise, the printers that are selected to replace the MFPs may match the MFPs in terms of recommended device output volume and output type and capability.

In another exemplary embodiment, the one or more auto-creation options may include a color-type replacement option in which one or more devices in the proposed state that print in a certain color (e.g., black-and-white or color) are replaced with devices that may print in another color. For example, the auto-creation options may include a color-to-mono option in which the auto-creation module 101a-2 (i) selects one or more devices in the proposed state that include an alternative to print in color and (ii) replaces the selected devices with devices that can only print in a single color (e.g., black-and-white). In addition, the replacement devices that are selected may match the devices to be replaced in terms of recommended device output volume and device type (e.g., printer, MFP, etc.). In another similar example, the auto-creation options may include an mono-to-color option in which the auto-creation module 101a-2 (i) selects one or more devices in the current state analysis that only print in one color (e.g., black-and-white) and (ii) replaces the selected devices with devices that can print in more than one color.

In yet another exemplary embodiment, the one or more auto-creation options may include a paper-size replacement option in which one or more devices in the proposed state that can print on a first paper size are replaced with devices that can print on a second paper size. For example, the auto-creation options may include an A3-to-A4 option in which the auto-creation module 101a-2 (i) selects one or more devices in the current state analysis that can print on A3 sized paper and (ii) replaces the selected devices with devices that can print on A4 sized paper. In addition, the replacement devices may match the devices that are to be replaced in terms of mono-color-capability, recommended device output volume and device type. It should be noted that in another example, the new replacement device may not have the capability to print on the first paper size. In other words, for example, when selecting the A3-to-A4 option, the replacement device may be able to print on A4 paper, but may not be able to print on A3 paper.

In yet another exemplary embodiment, the one or more auto-creation options may include a vendor replacement option in which one or more devices in the proposed state that is manufactured by a certain vendor (e.g., ABC, DEF, XYZ, etc.) are replaced with devices that are manufactured by another vendor. For example, the auto-creation options may include a replacement-by-vendor option in which the auto-creation module 101a-2 (i) selects one or more devices in the proposed state that are manufactured by XYZ Company and (ii) replaces the selected devices with devices manufactured by “Ricoh”. In addition, the replacement devices that are selected may match the devices to be replaced in terms of mono-color-capability, recommended device output volume, and device type (e.g., printer, MFP, etc.).

In yet another exemplary embodiment, the one or more auto-creation options may include a latest-model replacement option in which (i) the user selects a specific date and (ii) one or more devices in the proposed state, which have a release date that is on or before the specific date, are replaced with devices that have a release date that is after the specific date. The release date may be the date that a device is available to be purchased by the public. For example, the auto-creation options may include an old-to-new option in which the auto-creation module 101a-2 (i) selects one or more devices in the proposed state that have a release date on or before a specific date selected by the user and (ii) replaces the selected devices with devices that have release date after the specific date selected by the user. In addition, the replacement devices that are selected may match the devices to be replaced in terms of mono-color-capability, recommended device output volume, and device type (e.g., printer, MFP, etc.).

In yet another exemplary embodiment, the one or more auto-creation options may include an environmental-friendly replacement option in which one or more devices in the proposed state that are not environmental-friendly (e.g., uses too much energy, releases chemicals and gases dangerous to the environment, etc.) with devices that are environmental-friendly. For example, the auto-creation options may include a non-eco-to-eco option in which the auto-creation module 101a-2 (i) selects one or more devices in the proposed state that have not been “Energy Star Certified” by the Environmental Protection Agency (EPA) or the U.S. Department of Energy (DOE) and (ii) replaces the selected devices with devices that are “Energy Star Certified” by the EPA or the DOE. In addition, the replacement devices that are selected may match the devices to be replaced in terms of recommended device output volume, and device type (e.g., printer, MFP, etc.).

It should be noted that the recommended device output volume may be the recommended usage of the device. In other words, the volume (e.g., 2,000, 10,000, 400,0000) of papers being outputted when printing should be limited to a certain time period (e.g., daily, weekly, monthly, annually, etc.). Otherwise, by surpassing the recommended volume, the deterioration of the device may escalate. The output type and capability may include functions (e.g., printing, scanning, faxing, etc.) or features (e.g., stapling, n-up printing, color/mono, hole-punching, single/double side, etc.) of the device. In other words, for example, if the printer to be replaced includes a particular set of functions (stapling, hole-punching, color), the MFP for replacing the printer may include a set of functions that are the same as or similar to the particular set of functions.

It should be appreciated that not every printer or MFP is the same as each other. Each may include a different set of functions or properties (e.g., recommended device output volume) that may not completely overlap with the other. The device marketing (or fleet management or analysis) application determines a replacement device that is closest to (in terms of function and/or property) to the target device that is to be replaced.

The server 102 may be used to access information regarding customer device models and contracts data which are stored in the customer devices database 103 and database 104.

The customer devices database 103 may include information regarding a fleet of devices (e.g., printer, MFP, scanner, facsimile machine, etc.) for each customer. In other words, each customer may have an office, at a certain geographical location (e.g., city, town, etc.), that may include a fleet of devices. Information regarding each of the devices in the fleet of devices, such as name or identifier (e.g., device name, walkthrough ID, Asset tag, etc.), device type (e.g., printer, MFP, scanner, etc.), device functions (e.g., black & white, duplex, fax, scanning, N-up, etc.), physical location, network address (e.g., IP address, MAC address, etc.), output technology (e.g., laser, inkjet solid ink, thermal, other technology, etc.), supply level (e.g., level of consumable, such as paper and toner, is empty, low, ok, etc.), pages per job (e.g., 1, 2, 6-10, etc.), color technology (e.g., professional color, convenience color, etc.), device properties (e.g., manufacturer, model, serial number, etc.), etc. are stored in the customer devices database 103.

In another example, the customer device information in the customer devices database 103 may in the form of a spreadsheet (e.g., Excel). In other words, the user may request from the customer information on the fleet of devices currently possessed by the customer by having the customer fill out an electronic spreadsheet with data (e.g., identifier, device type, functions, color technology, etc.) corresponding to each device. Such spreadsheet may be sent to the user electronically (e.g., e-mail), after which, the spreadsheet is stored in the customer devices database 103.

The state analysis database 104 registers any type of state analyses previously created by the user. In other words, the state analysis database 104 may include current state analyses corresponding to one or more customers and/or previously created proposed analyses. It should be noted that the database does not necessarily link a proposed state analysis for a particular customer. In other words, a proposed state analysis may be created in future anticipation of a type of customer. For example, the company that the user works for may have a specific proposed state analysis which includes one or more recently created products (to be used together) that are designed for companies in the information technology (IT) industry. However, the company employing the user may not yet have any customers from the IT industry. As a result, there is no company linked with the specific proposed state analysis. When the device marketing or fleet management application 101a receives instructions to create a proposed state analysis, the device marketing or fleet management application 101a may request access to the state analysis database 104 from the server 102 for the purpose of obtaining an existing current/proposed state analysis.

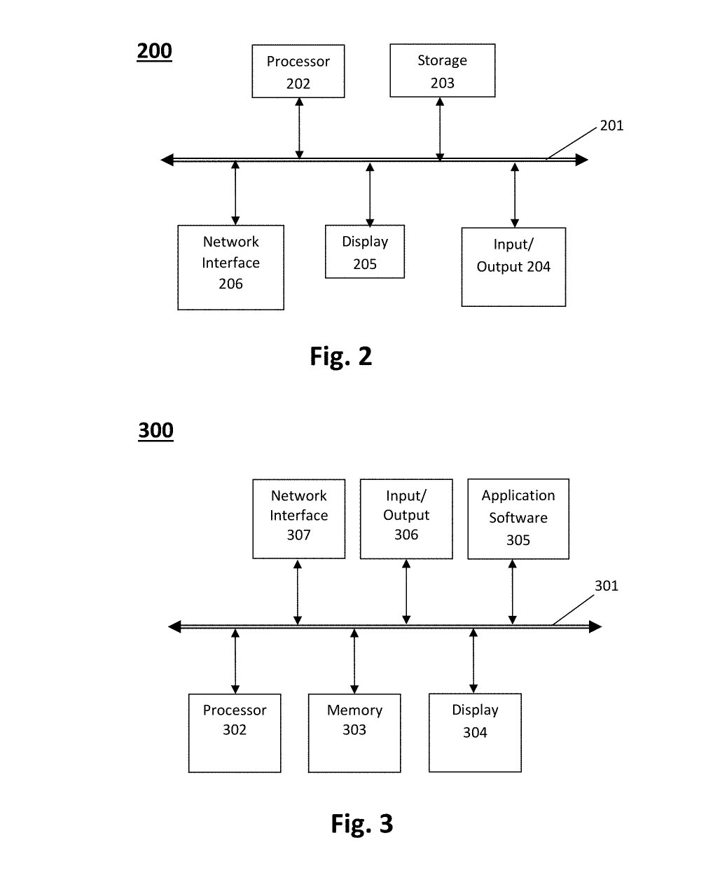

Therefore the user may access the server 102 to obtain previously registered current/proposed state analyses and information regarding customer devices without having to manually input the information, thereby making it more convenient for the use. The server 102 is further described infra with reference to FIG. 2.

The network 107 can be a local area network, a wide area network or any type of network such as an intranet, an extranet (for example, to provide controlled access to external users, for example through the Internet), a private or public cloud network, the Internet, etc., or a combination thereof. Further, other communications links (such as a virtual private network, a wireless link, etc.) may be used as well for the network 106. In addition, the network 106 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

FIG. 1B shows schematically a system 100B, according to another exemplary embodiment. The system 100B is similar to the system 100A of FIG. 1A except that the system additionally includes a third party source 105.

The third party source database 105 may be a database belonging to any number of third party entities. Further, there may more than one third party source database connected to the network 107. For example, the third party source database may belong to an organization such as a device manufacturer, a retail vendor, etc. Each of the aforementioned organizations may publicly store device models that they are selling. Thus, in the case that the user of the terminal 101 attempts to obtain the devices currently being possessed by a customer by accessing a spreadsheet sent by the customer, the user may discover that the spreadsheet is missing certain information (e.g., price, functions, monthly volume, energy usage, etc.). This may be because the customer simply does not have knowledge of every device in their possession. Consequently, the device marketing or fleet management application 101a may automatically communicate with the third party source database 105 to obtain the missing device information and complete the spreadsheet.

Otherwise, operations of the elements of the system 100B are similar to those discussed in connection with the corresponding elements of the system 100A of FIG. 1A.

FIG. 2 shows an exemplary constitution of a computing device that can be configured (for example, through software) to operate (at least in part) as a terminal (e.g., 101 in FIGS. 1A and 1B) or a central or server device (e.g., 102 in FIGS. 1A and 1B). In FIG. 2, apparatus 200 includes a processor (or central processing unit) 202 that communicates with a number of other components, including memory or storage device 203, display 205, other input/output (e.g., keyboard, mouse, etc.) 204, and network interface 206, by way of a system bus 201. The apparatus 200 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as should be appreciated by those skilled in the relevant art. In the management apparatus 200, the processor 202 executes program code instructions that control device operations. The processor 202, memory/storage 203, input/output 204, display 205 and network interface 206 are conventional, and therefore in order to avoid obfuscating the inventive aspects of this disclosure, such conventional aspects are not discussed in detail herein.

The apparatus 200 includes the network interface 206 for communications through a network, such as communications through the network 107. However, it should be appreciated that the subject matter of this disclosure is not limited to such configuration. For example, the apparatus 200 may communicate with user terminals through direct connections and/or through a network to which some components are not connected. As another example, the apparatus 200 does not need to be provided as a server that services terminals, but rather may communicate with the devices on a peer basis, or in another fashion.

The apparatus 200 of the present disclosure is not limited to a server or computer, but can be manifested in any of various devices that can be configured to communicate over a network and/or the Internet.

An exemplary constitution of the client device 101 of FIGS. 1A and 1B is shown schematically in FIG. 3. In FIG. 3, terminal 300 includes a processor (or central processing unit) 302 that communicates with various other components, such as memory (and/or other storage device) 303, display 304, application software 305, input/output (such as keyboard, mouse, touchpad, stylus, microphone and/or speaker with voice/speech interface and/or recognition software, etc.) 306, and network interface 307, by way of an internal bus 301.

The memory 303 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 307 provides a connection (for example, by way of an Ethernet connection or other network connection which supports any desired network protocol such as, but not limited to TCP/IP, IPX, IPX/SPX, NetBEUI, etc.) to the network to which the computer 300 is connected (e.g., network 107 of FIG. 1).

Additional aspects or components of the computer 300 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

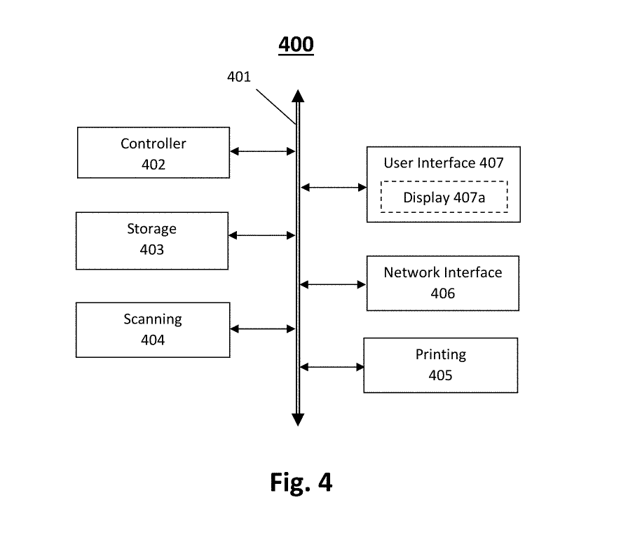

FIG. 4 shows a schematic diagram of a configuration of an output device as an MFP (multi-function printer or multi-function peripheral) device. The output device 400 shown in FIG. 4 includes a controller 402, and various elements connected to the controller 402 by an internal bus 401. The controller 402 controls and monitors operations of the output device 400. The elements connected to the controller 402 include storage 403 (for example, random access memory, read-only memory, hard disk drive, portable storage media drive such as for optical discs, magnetic discs, magneto optical discs, etc., semiconductor memory cards, combinations of storage media, etc.), scanning provisions 404, printing provisions 405, a network interface (I/F) 406, and a user interface 407 including display 407a.

Storage 403 can include one or more storage parts or devices [e.g., a read only memory (for example, ROM, PROM, EPROM, EEPROM, etc.), a random access memory (RAM), a hard disk drive (HDD), portable media (for example, floppy disk, optical disc, magnetic discs, magneto-optical discs, semiconductor memory cards, etc.) drives], and program code instructions can be stored in one or more parts or devices of storage 403 and executed by the controller 402 to carry out the instructions. Such instructions can include instructions for performing specified functions (such as printing, scanning, faxing, copying, e-mailing, etc.) of the output device 400, to enable the output device 400 to interact with a terminal, as well as perhaps other external devices, through the network interface 406, and interactions with users through the user interface 407.

The network interface 406 is utilized by the output device 400 to communicate via a network with other network-connected devices such as a terminal, a server and receive data requests, print (or other) jobs, user interfaces, and etc.

The user interface 407 includes one or more electronic visual displays that display, under control of controller 402, information allowing the user of the output device 400 to interact with the output device 400. The electronic visual display can be any of various conventional displays (such as a liquid crystal display, a plasma display device, a cathode ray tube display, etc.), but preferably is equipped with a touch sensitive display (for example, liquid crystal display) and is configured to provide a GUI (graphical user interface) based on information input by an operator of the output device 400, so as to allow the operator to interact conveniently with services provided on the output device 400, or with the output device 400 serving as terminal for accessing electronic data or other content through the network. User interfaces or other contents received through the network via the network interface 406 can be displayed on the display screen.

The display screen does not need to be integral with, or embedded in, a housing of the output device 400, but may simply be coupled to the output device 400 by either a wire or a wireless connection. The user interface 407 may include keys and/or buttons (such as graphical keys or buttons, or other graphical elements, of a GUI on a touchscreen display 407a) for inputting information or requesting various operations. Alternatively, the user interface 407 and the display screen may be operated by a keyboard, a mouse, a remote control, voice recognition, or eye-5 movement tracking, or a combination thereof.

Since the output device 400 is typically shared by a number of users, and is typically stationed in a common area, the output device 400 preferably prompts the user to supply login credentials or authentication information, such as user name (or other user or group information), password, access code, etc. The user credentials may be stored for the session and automatically supplied for access to other devices through the network. On the other hand, such other devices may prompt the user to supply other user credentials through the user interface. Other methods of authentication may also be used. For example, the MFD 400 may be equipped with a card reader or one or more biometrics means (such as comparing fingerprints, palm prints, voice or speech, retinas or irises, facial expressions or features, signature, etc.). The MFD 400 may communicate the user credentials, provided in the manners discussed above, to other devices or applications connected to the MFD 400 via a network (e.g., the network 107 of FIGS. 1A-1B) for determining authorization for performing jobs.

Scanning provisions 404, printing provisions 405, and network interface 406 are otherwise conventional, and therefore, a detailed description of such conventional aspects is omitted in the interest of clarity and brevity. The output device 400 can have any or all of the functions of similar devices conventionally known, such as for scanning, editing and storing images, sending a fax, sending and receiving e-mails with or without attachments, accessing files by FTP or another protocol or facility, surfing the Web, scan-to-folder, scan-to-email, etc. Further, multi-functional devices or multi-function peripheral devices can play a prominent role to convert hardcopy documents to electronic documents.

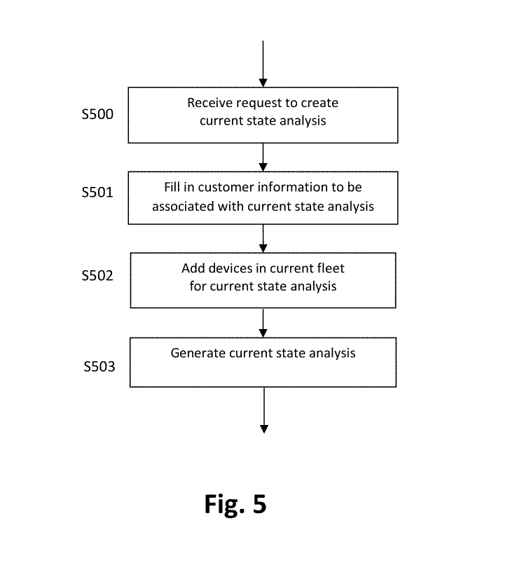

FIG. 5 show a method that can be performed by or with a fleet analysis, device marketing or fleet management application (e.g., 101a) on a terminal apparatus (e.g., 101), according to an exemplary embodiment.

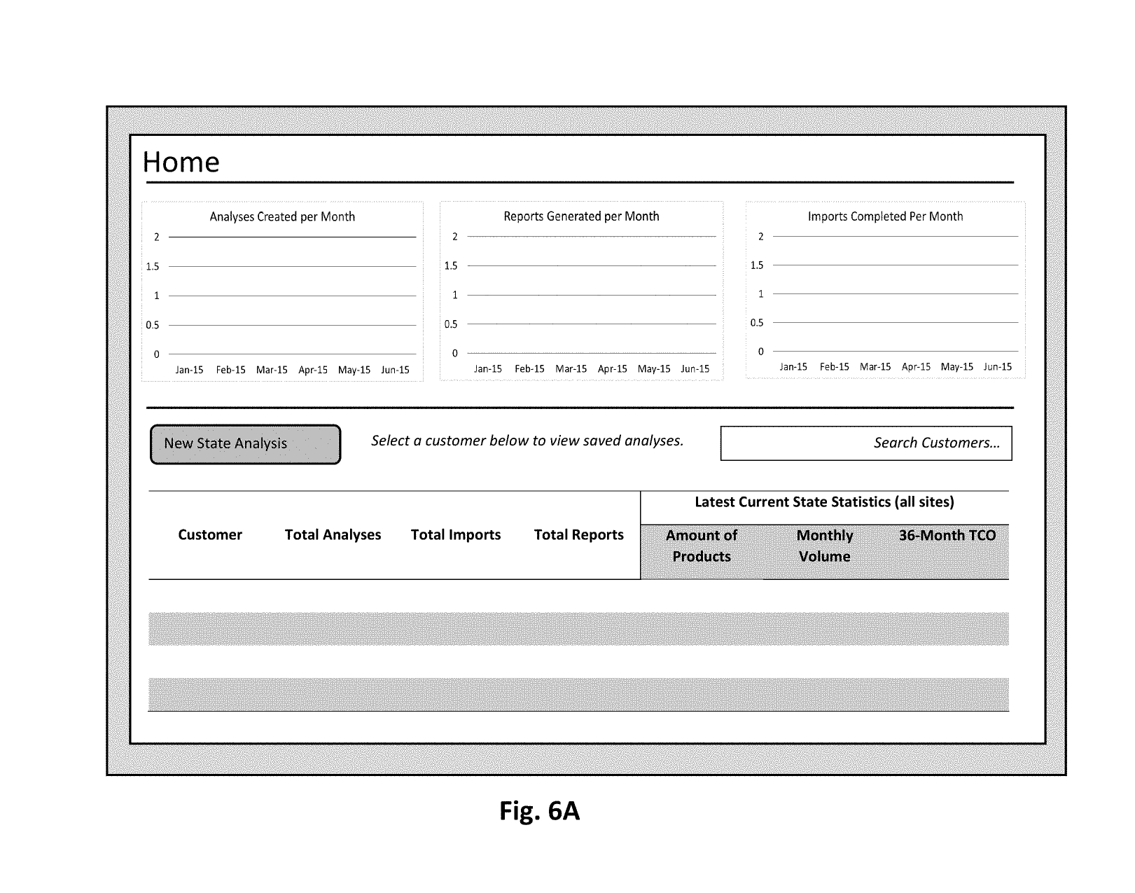

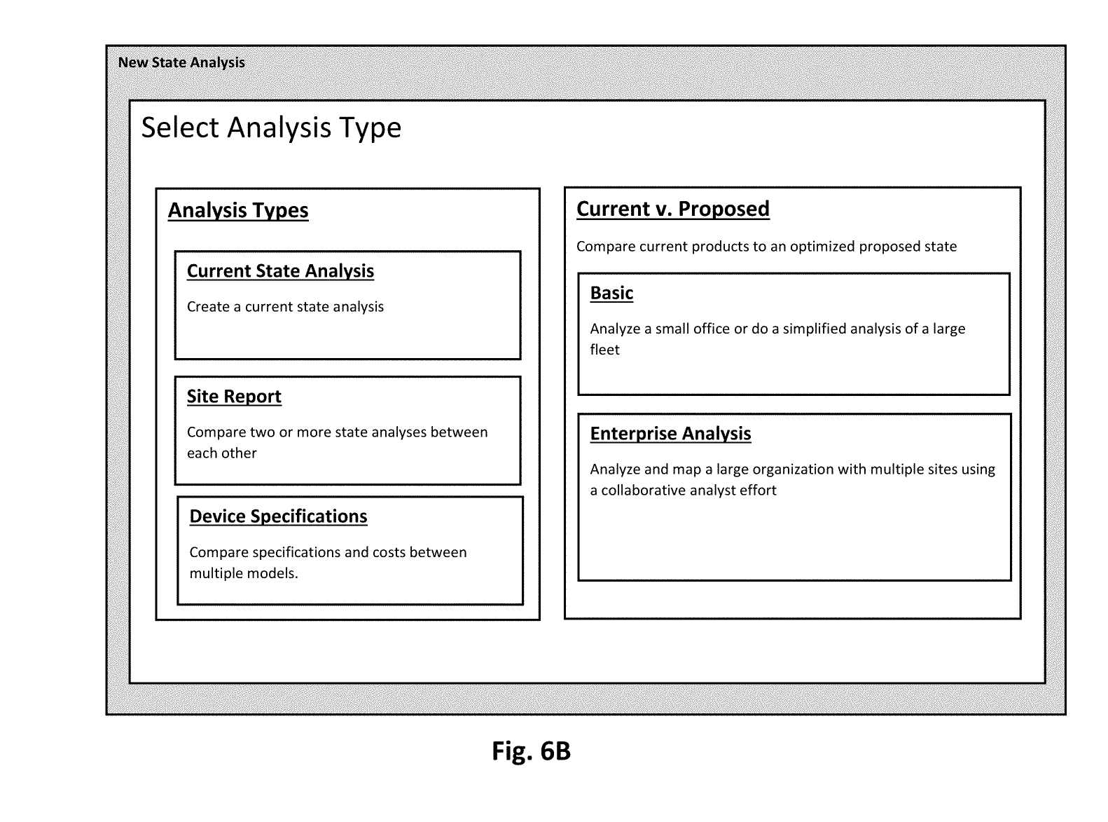

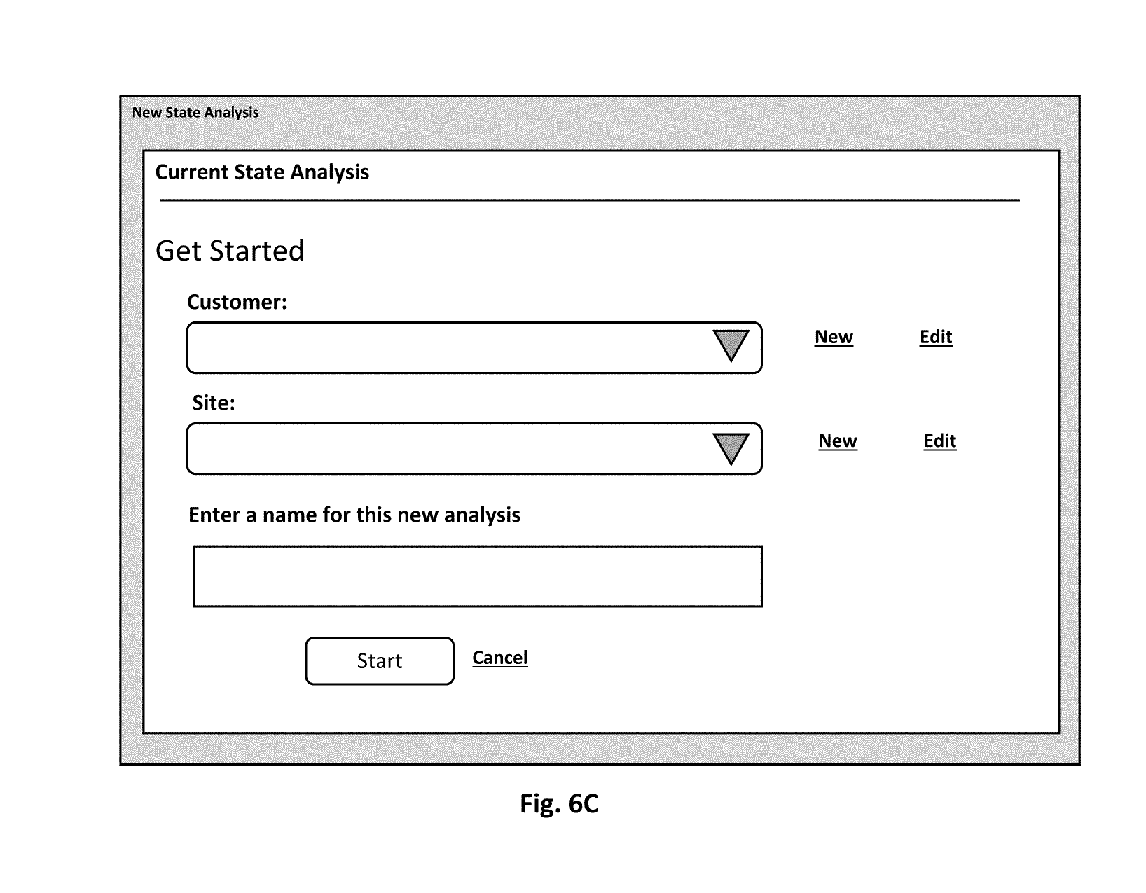

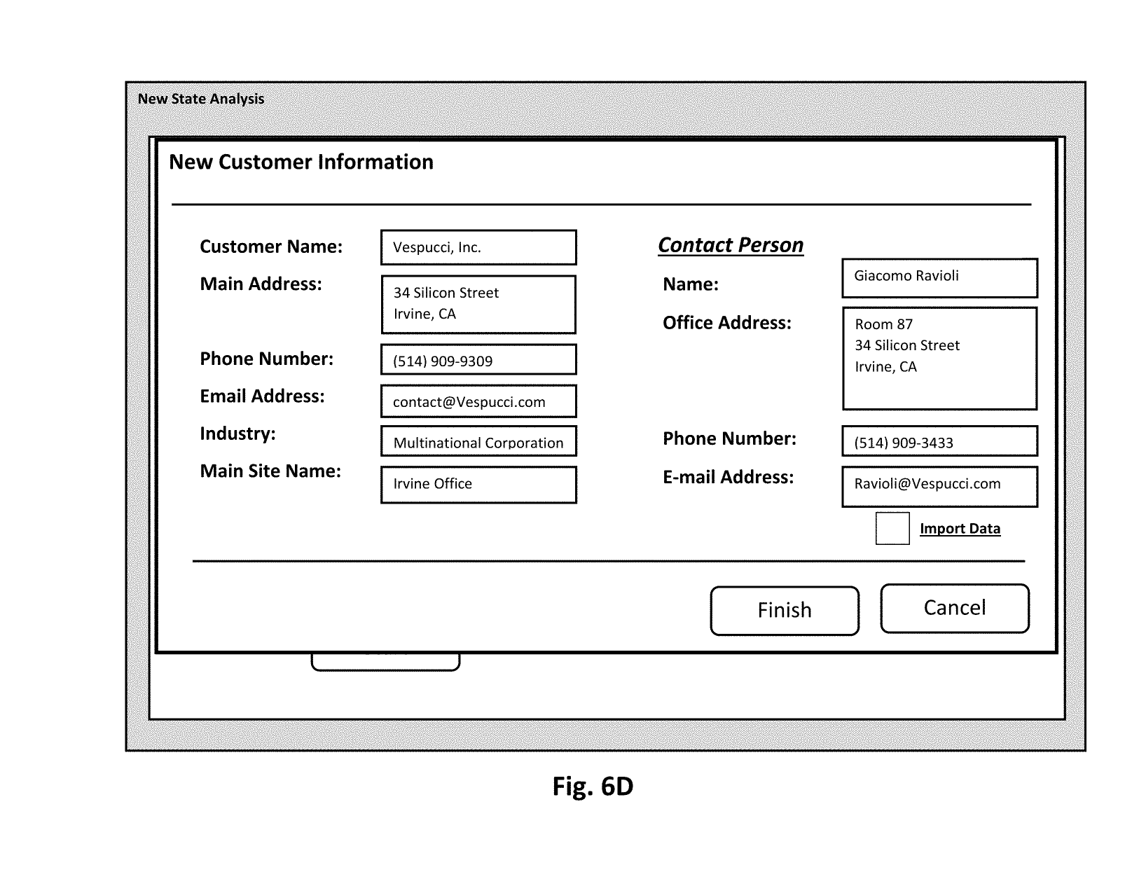

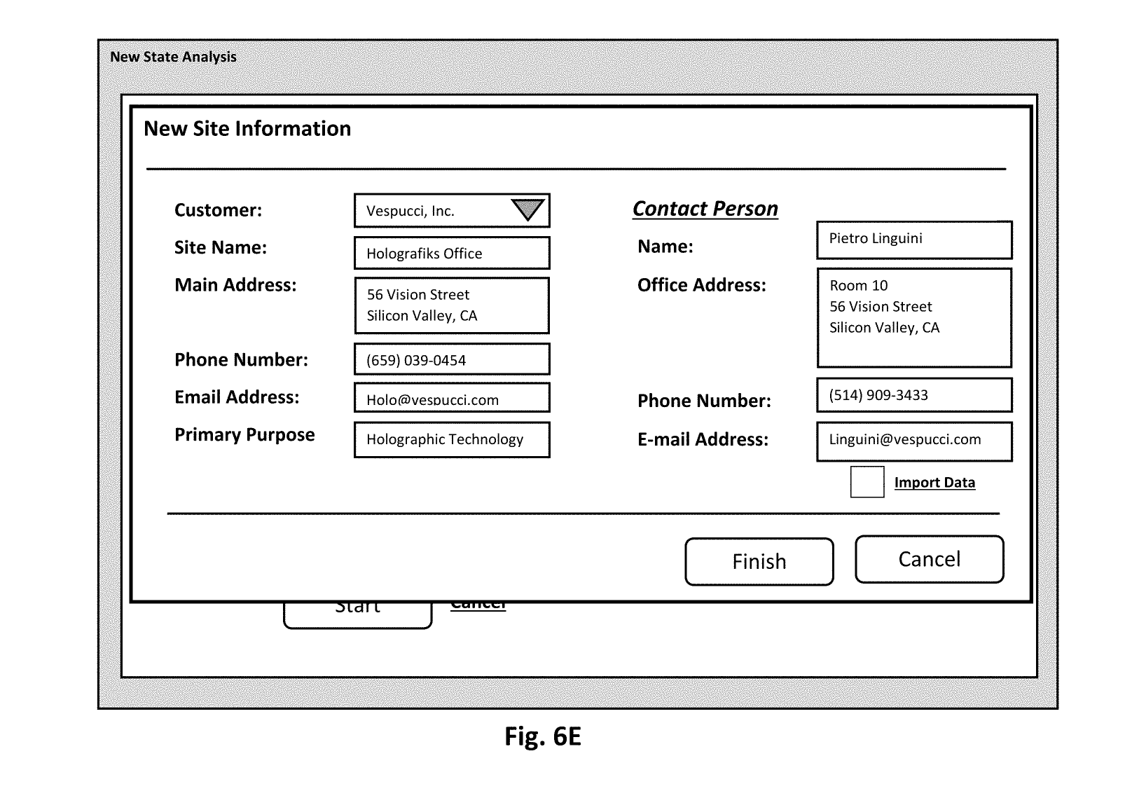

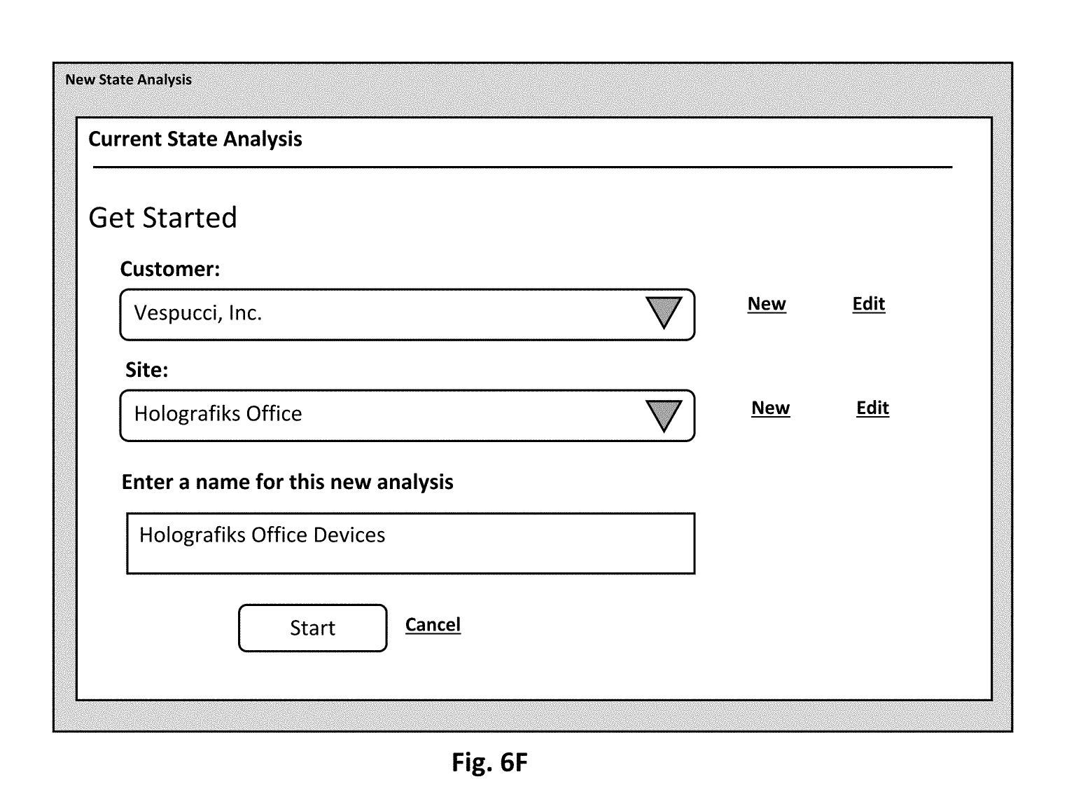

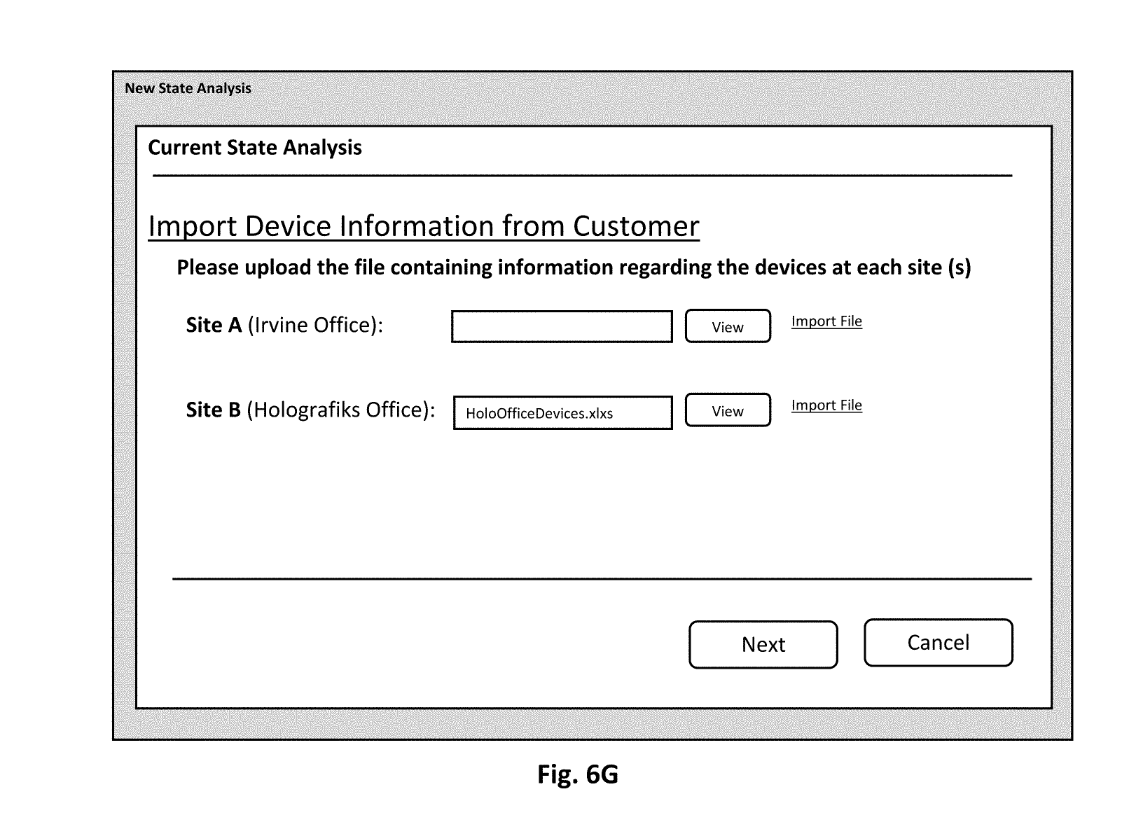

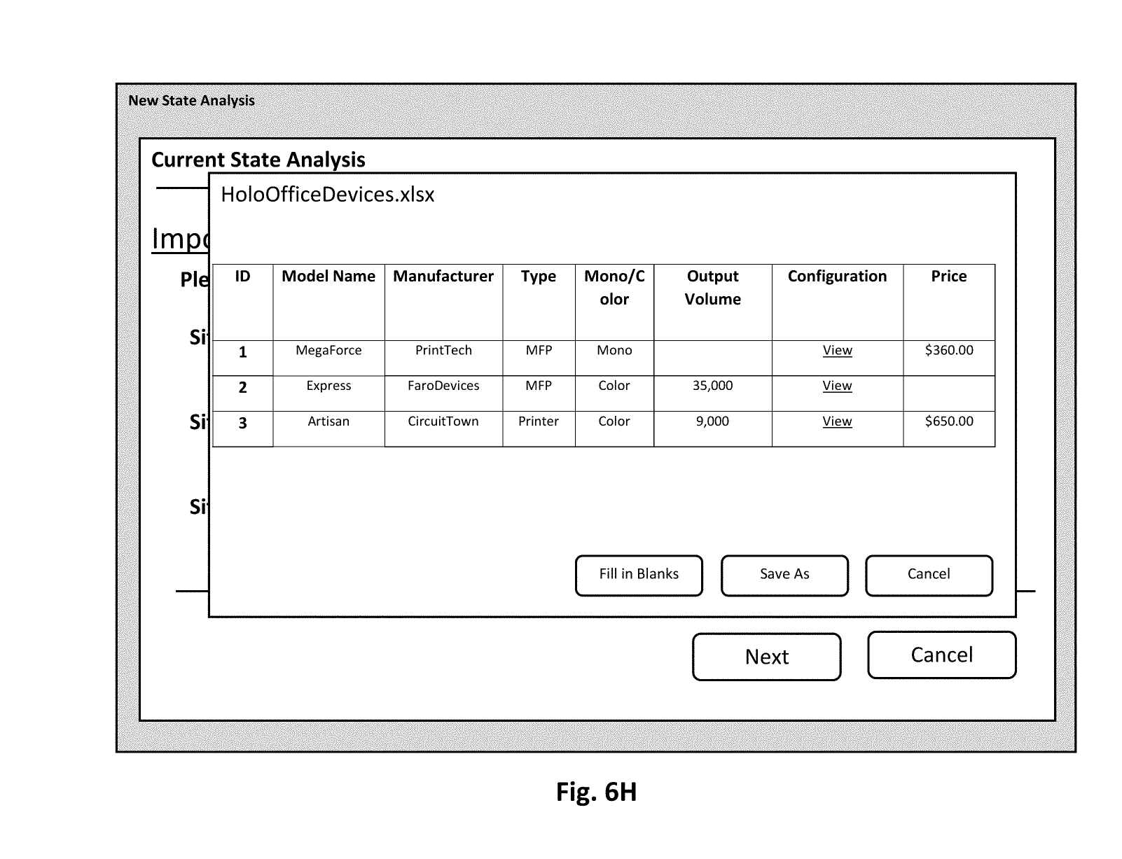

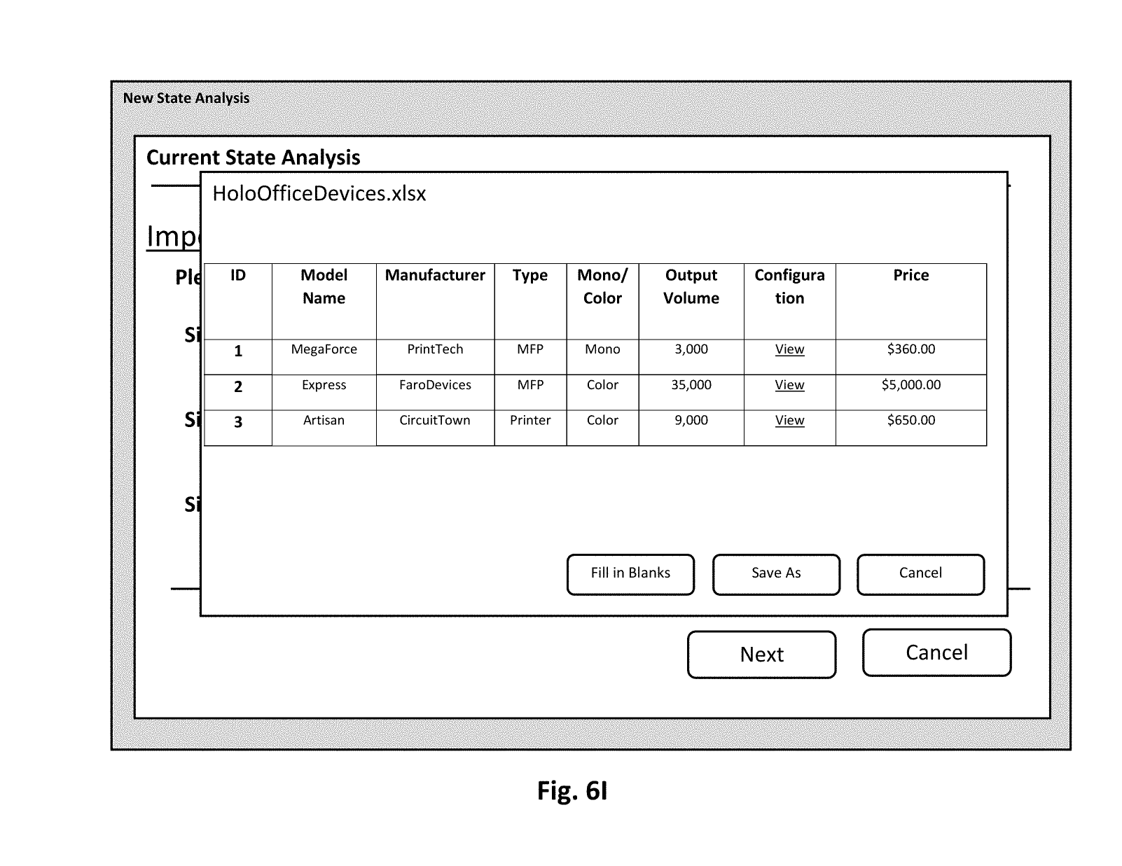

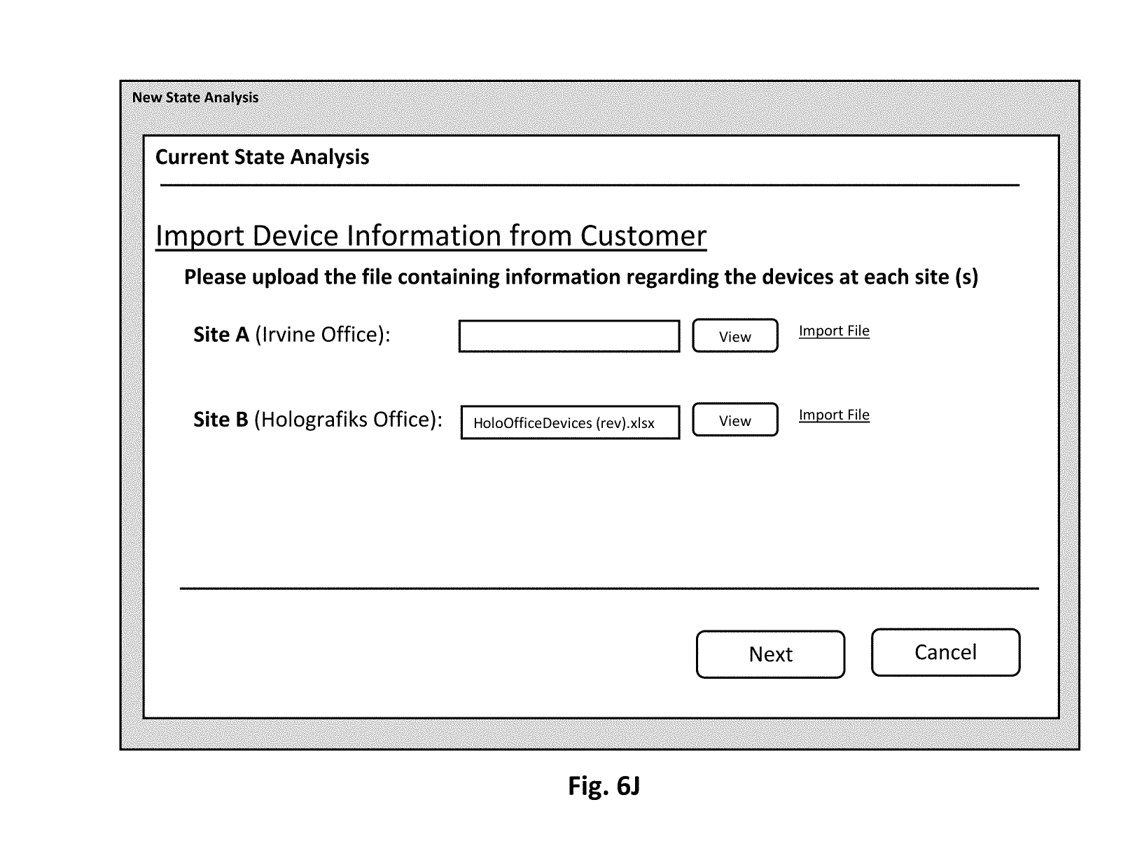

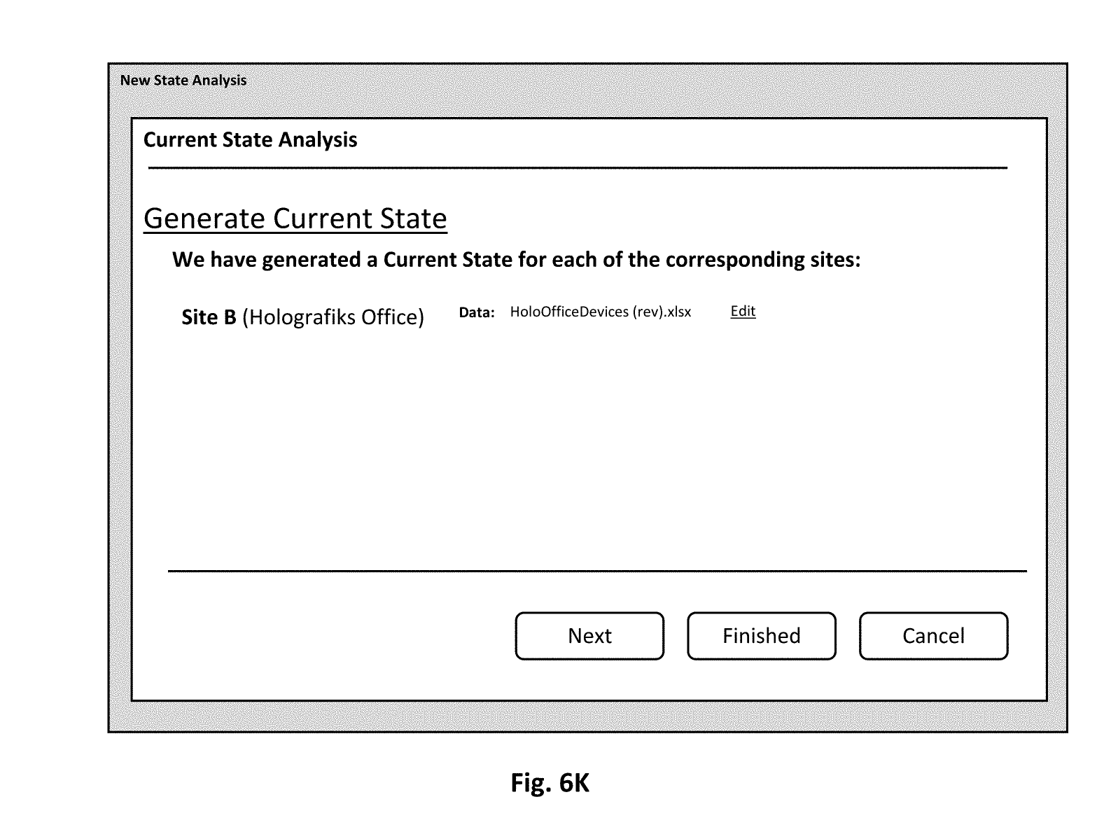

In an example of a workflow discussed below with reference to FIG. 6A through FIG. 6K, a user (e.g. “Harold”) at “Ricoh Corporation” has responsibilities such as advising potential (or existing) customers what device models manufactured by Ricoh would be suitable for them, and here the customer Vespucci, Inc. seeks to replace the fleet of devices employed by its subsidiary Holografiks. A Vespucci manager (hereinafter “customer” or “customer manager”) discovered that many devices in the Holografiks office (i) are inefficient, (ii) include unnecessary functions, (iii) are outdated, (iv) lack necessary functions and/or (v) are energy consuming. As a result, this has contributed to high overhead costs and low productivity.

The customer has determined that Ricoh may offer the best devices in terms of quality and therefore decides to contact (e.g., telephone, email, etc.) Ricoh to negotiate purchasing or leasing Ricoh devices. The user Harold responds to the customer inquiry, and the customer requests a proposal of devices that would be suitable for replacing the devices in the Holografiks office. In response, the user sends a spreadsheet to the customer and asks him to fill out the spreadsheet with data on the devices to be replaced.

When the user receives the completed spreadsheet that includes the requested information regarding the devices to be replaced, the user can now start creating a customer profile by activating the “New State Analysis” button (S500), such as shown in FIG. 6A. Next, since the user is doing a current state analysis, he activates the “Current State Analysis” button, such as shown in FIG. 6B. In response, the user is shown a screen for getting started, such as shown in FIG. 6C. Since this customer is a new customer, the user activates the “New” button next to the Customer field which causes a screen for entering new customer information to be presented to the user (S501), such as shown in FIG. 6D. After entering the relevant customer information, the user activates the “Finished” button which causes a new customer object to be added to the application database (e.g., 103 in FIGS. 1A and 1B).

In addition, the user can create a customer site by activating the “New” button next to the Site field which causes a screen for entering new site information to be presented to the user, such as shown in FIG. 6E. The user enters information in fields that are similar to the fields shown previously in the screen illustrated in FIG. 6D. After entering the relevant customer information, the user activates the “Finished” button which causes the new site object to be added for the customer. Next, the user selects the customer (i.e. Vespucci, Inc.) and site (i.e. Holografiks Office) information from the drop down menu and activates the “Start” button, such as shown in FIG. 6F. After the user has activated the “Start” button, he can begin adding devices to the current state analysis (S502).

The user can do this by electronically uploading the spreadsheet received from the customer. For example, the fleet analysis or device marketing or fleet management application requests the user to import information regarding the devices at each of the customer sites (i.e. “Site A” and “Site B”), such as shown in FIG. 6G. Further, the user may also view the file given to him by the customer, such as shown in FIG. 6H.

For example, the file including the information of each device at a certain site (e.g., Holografiks office) may not be complete. It may be that records were destroyed or lost causing the customer to fill out the form only partially (as evident from blank spaces in the spreadsheet shown in FIG. 6H). It should be noted that in the case that there is an identifier “N/A” in the spreadsheet, it does not mean that the customer does not know the value regarding that particular information. Instead, the customer understands that such value may not exist. For example, a device “Workforce” may have an “N/A” under the category “Rental Price” because the device “Workforce” cannot be rented (i.e. only purchasable) and not because the customer does not know what value to put in that category.

Thus, when there is incomplete information in the table of devices, the user can complete the table by activating the “Fill in Blanks” button which causes the device marketing or fleet management application to communicate with a third party source (e.g., Amazon, Best Buy, Newegg, Staples, PC Richard and Son, etc.) to obtain information that can complete the table. Once the table is completed, such as shown in FIG. 6I, the user can save the completed table by activating the “Save As” button which causes the file to be saved as “HoloOfficeDevices(rev).xlsx”, such as shown in FIG. 6J. It should be noted that since the user is only generating the current state analysis for the Holografiks office, the user is not required to import data files for the other sites (i.e. Irvine Office). Thus, when the user activates the “Next” button, a current state analysis is generated only for the Holografiks office (S503), such as shown in FIG. 6K.

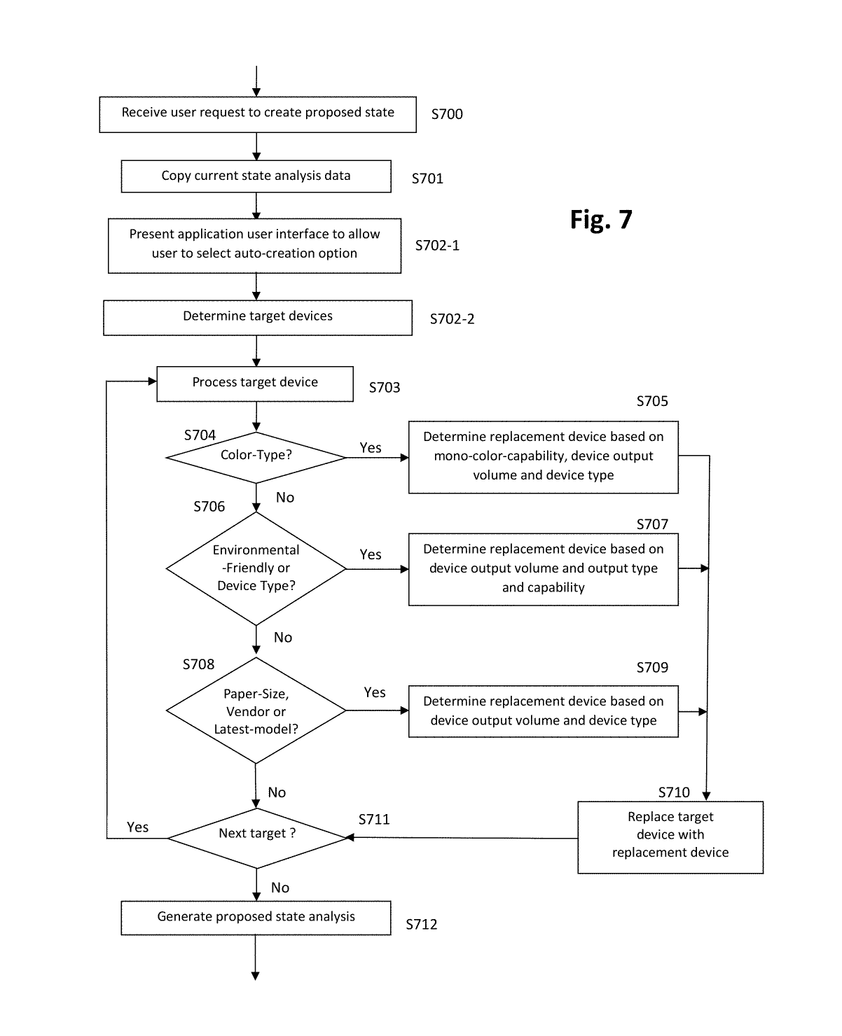

FIG. 7 show a method that can be performed by or with a fleet analysis or device marketing or fleet management application (e.g., 101a) on a terminal apparatus (e.g., 101), according to an exemplary embodiment.

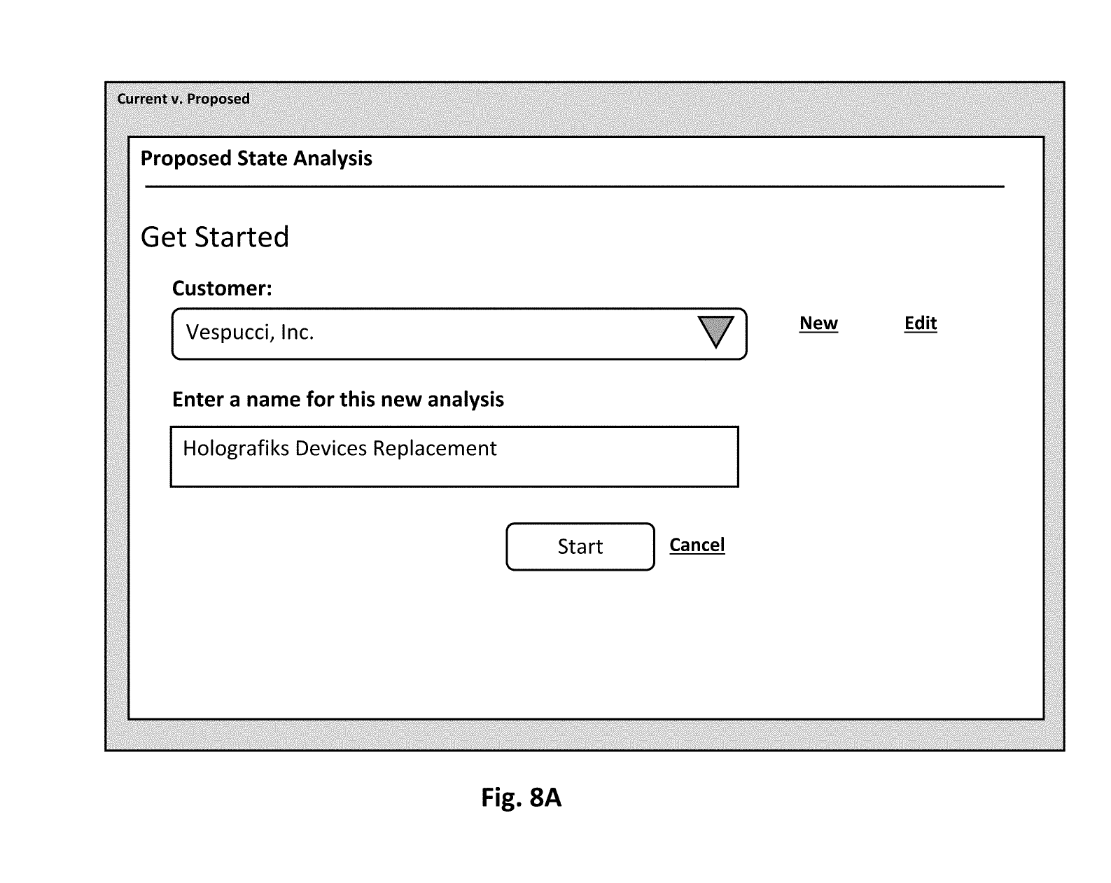

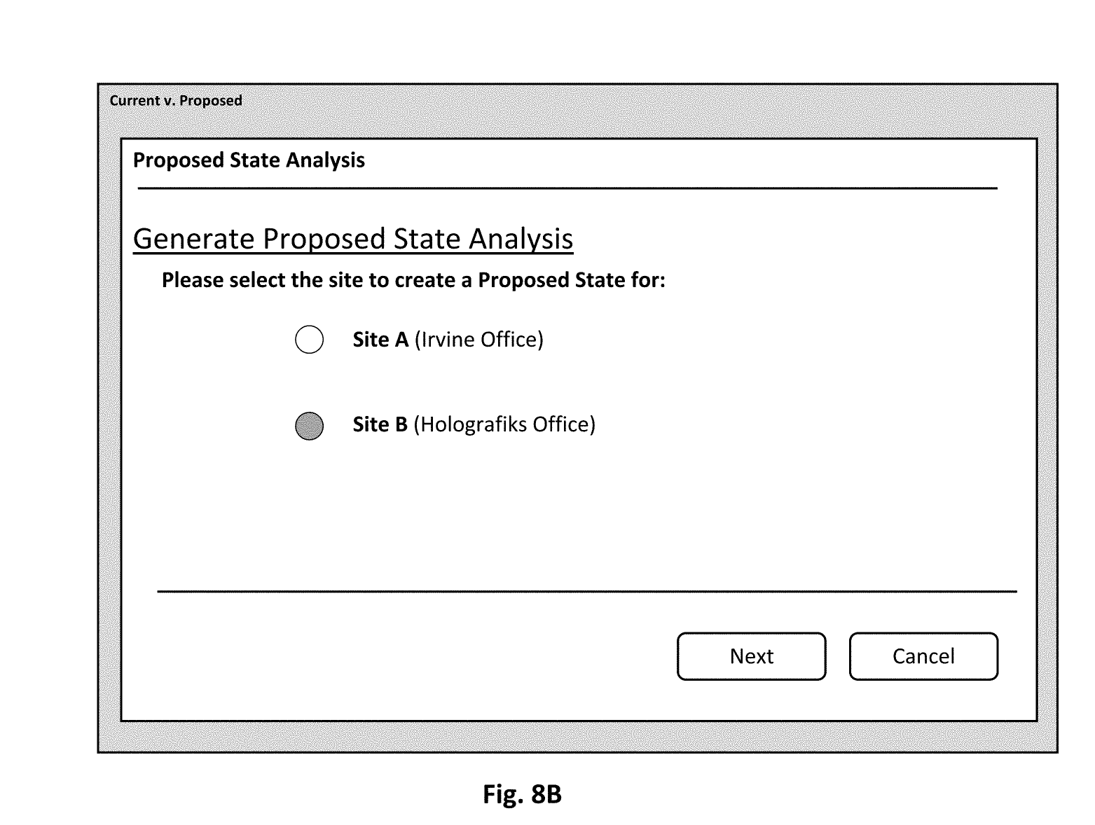

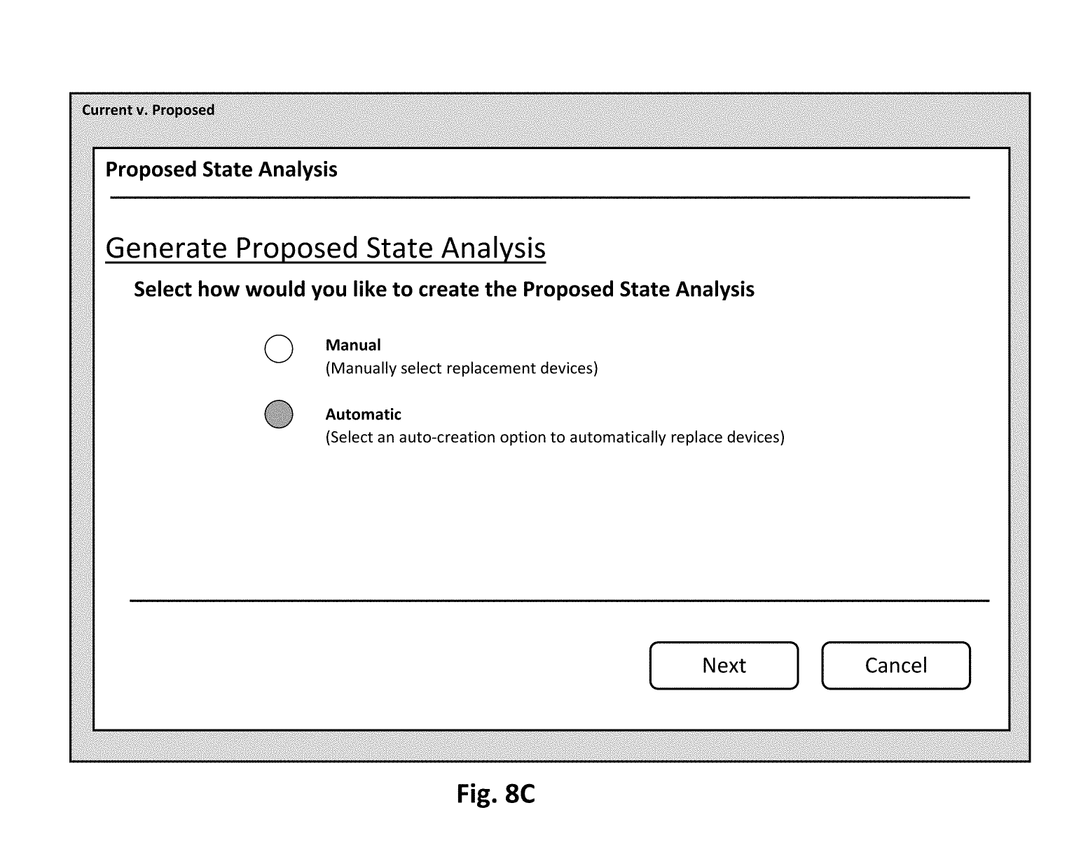

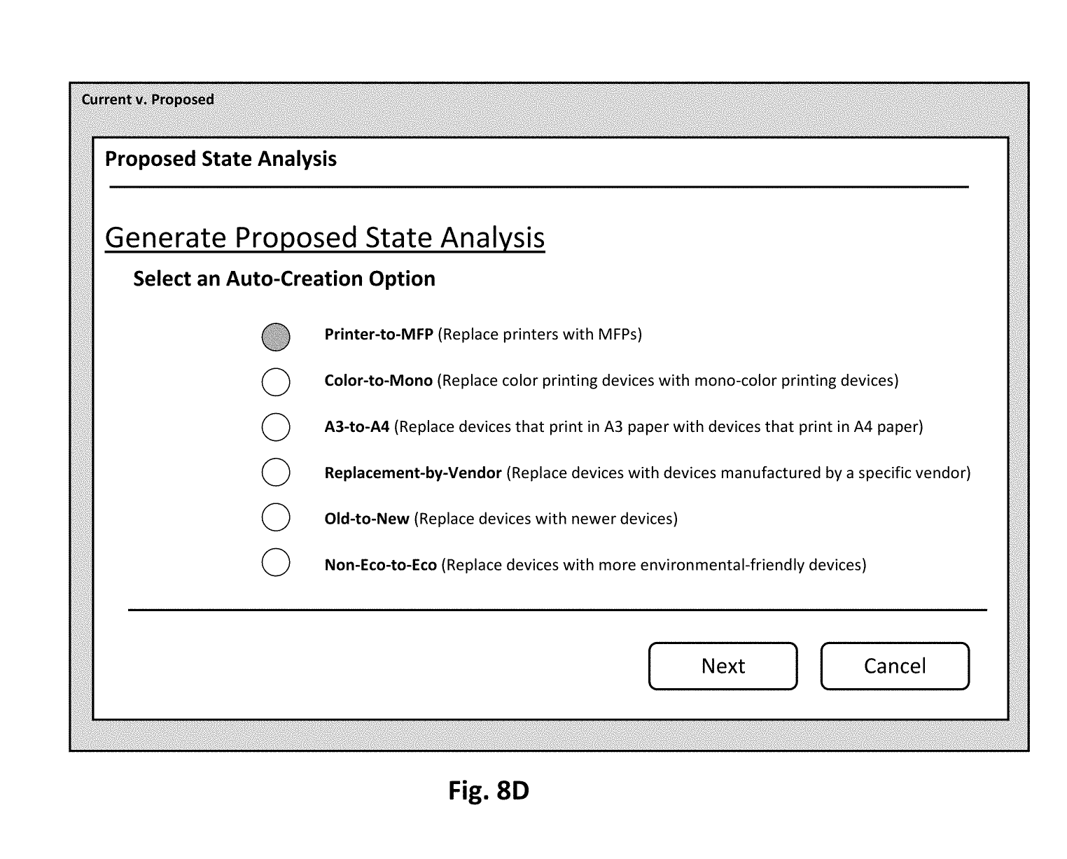

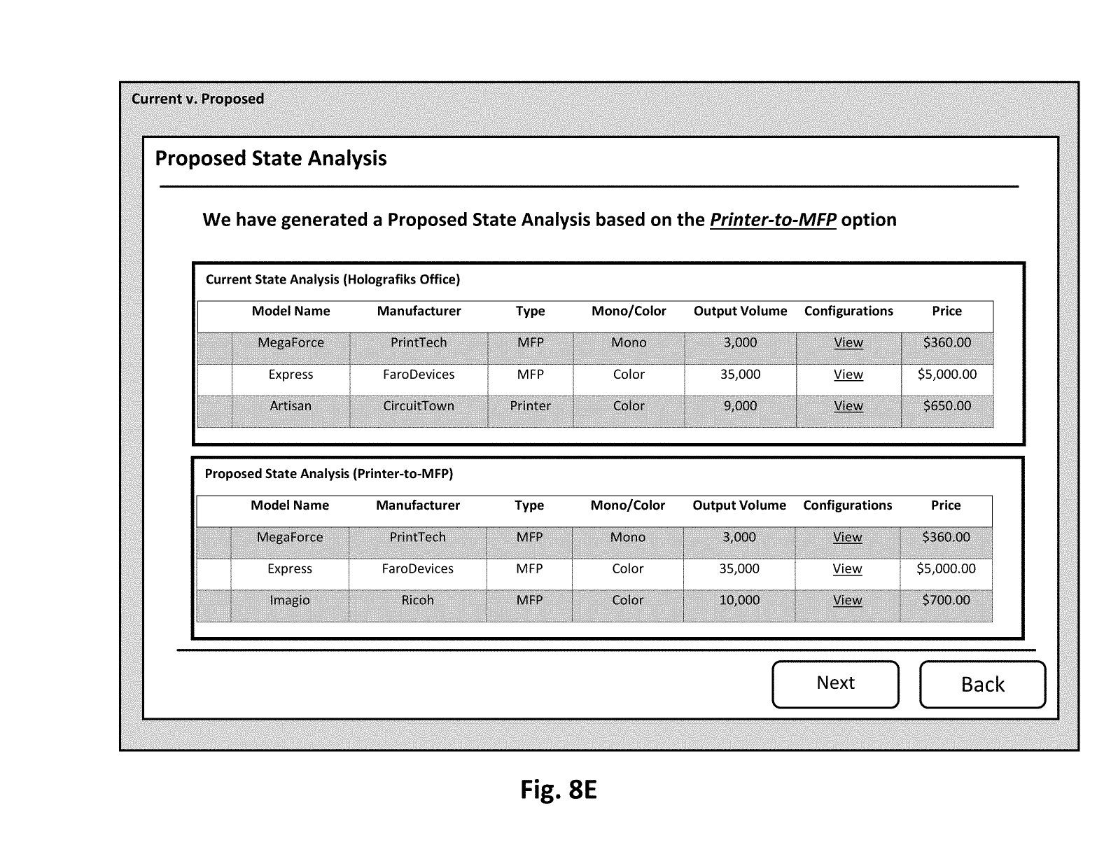

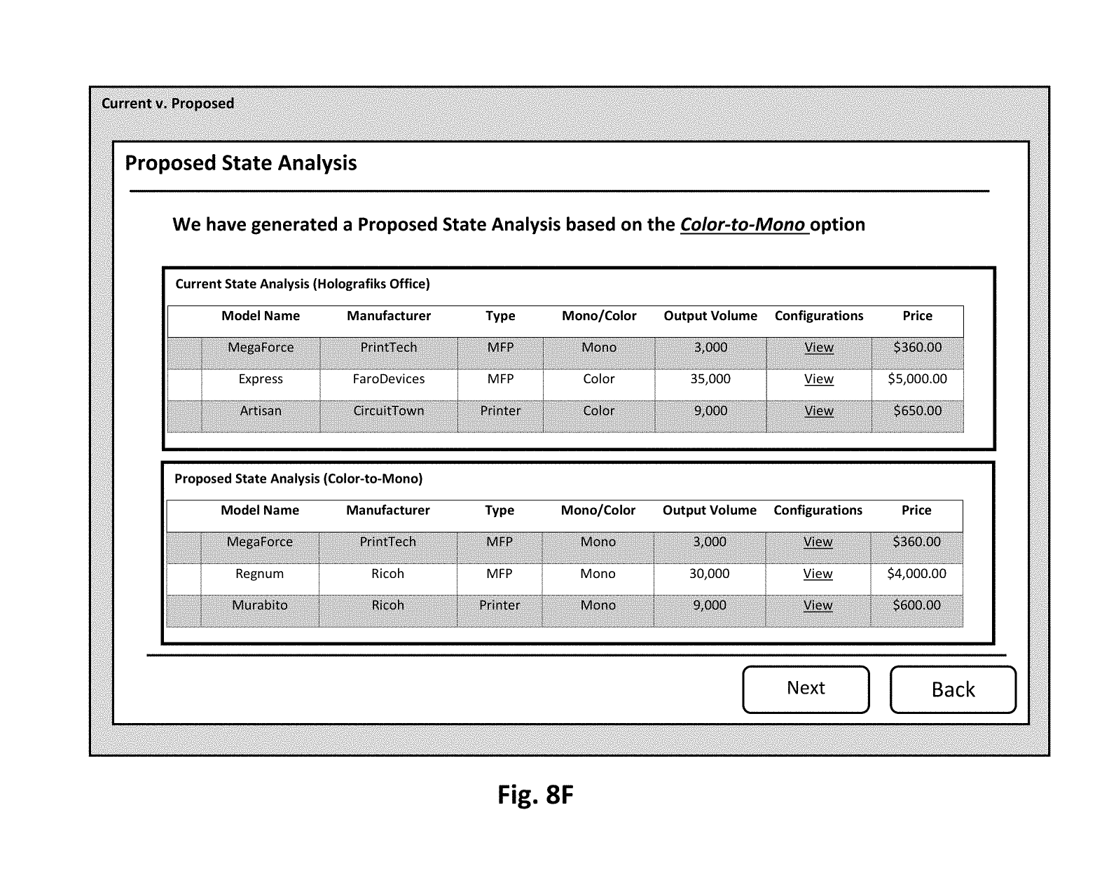

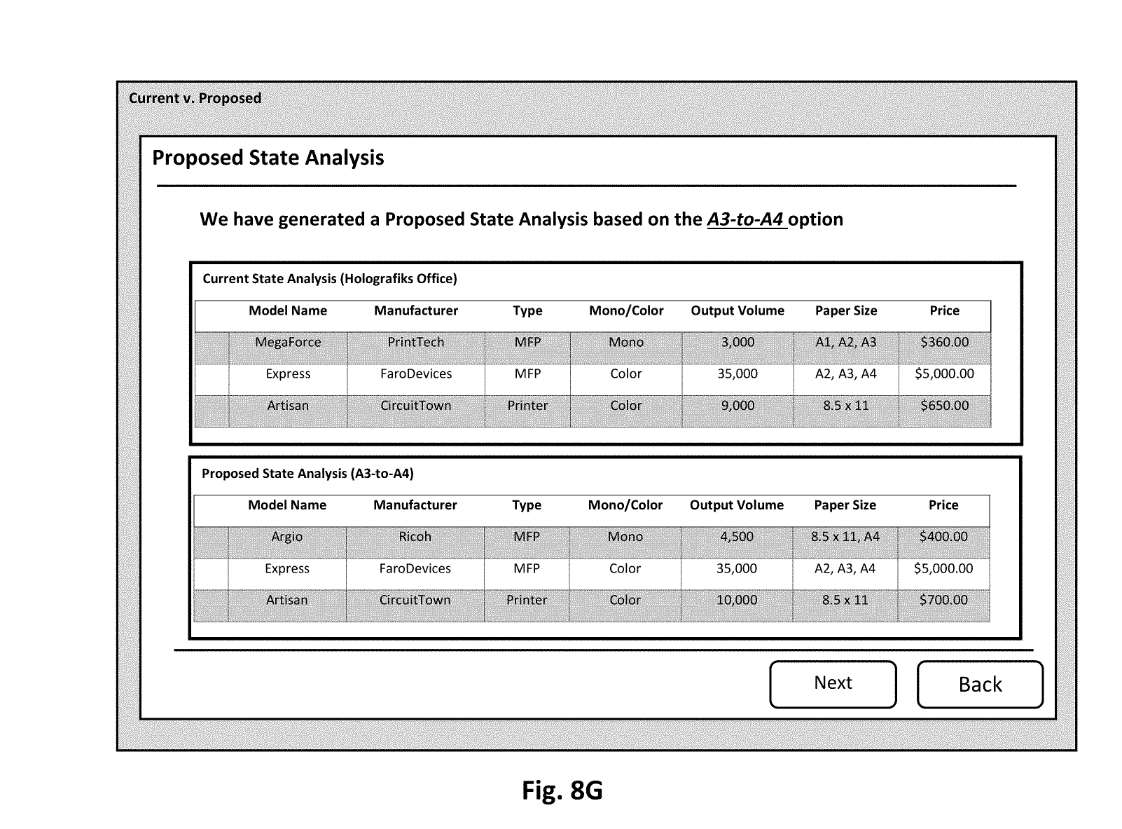

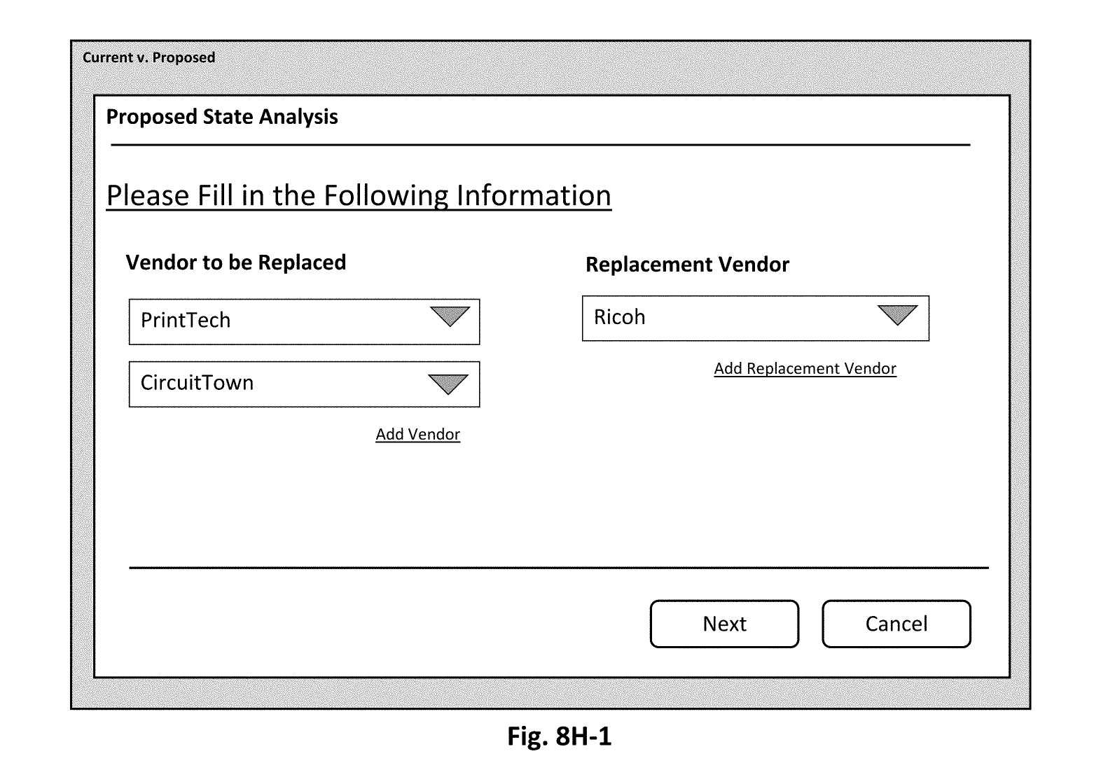

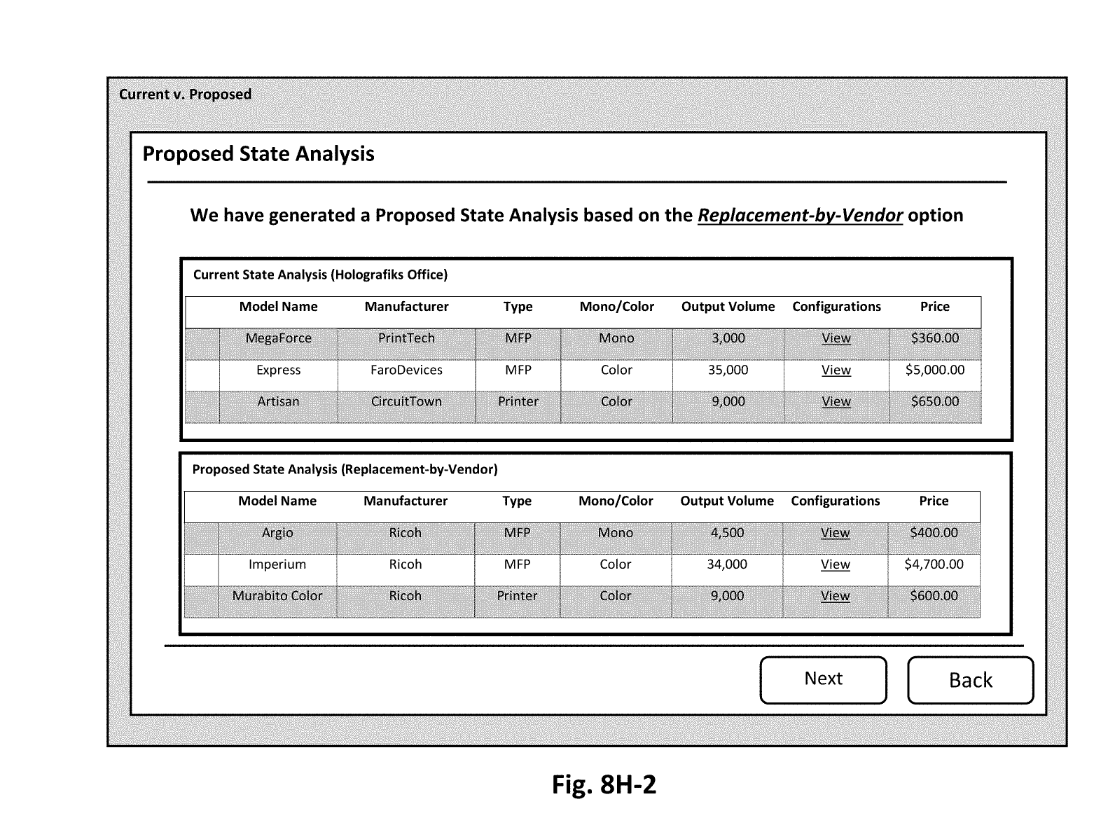

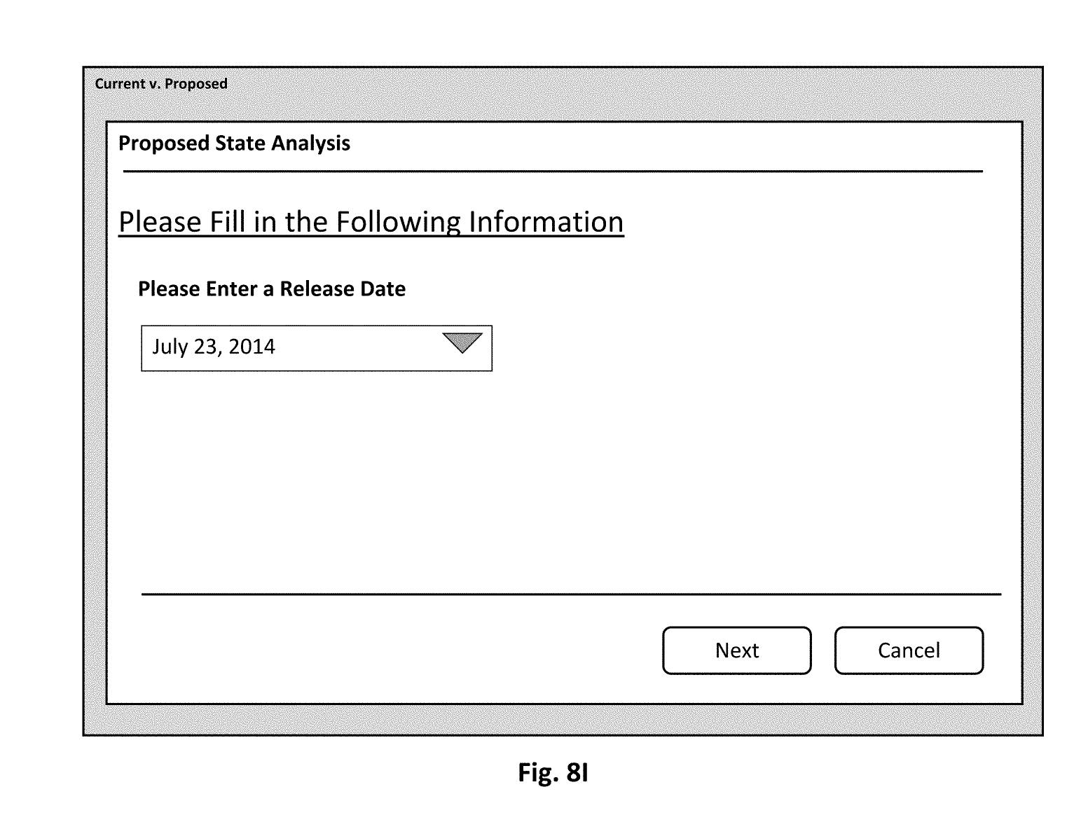

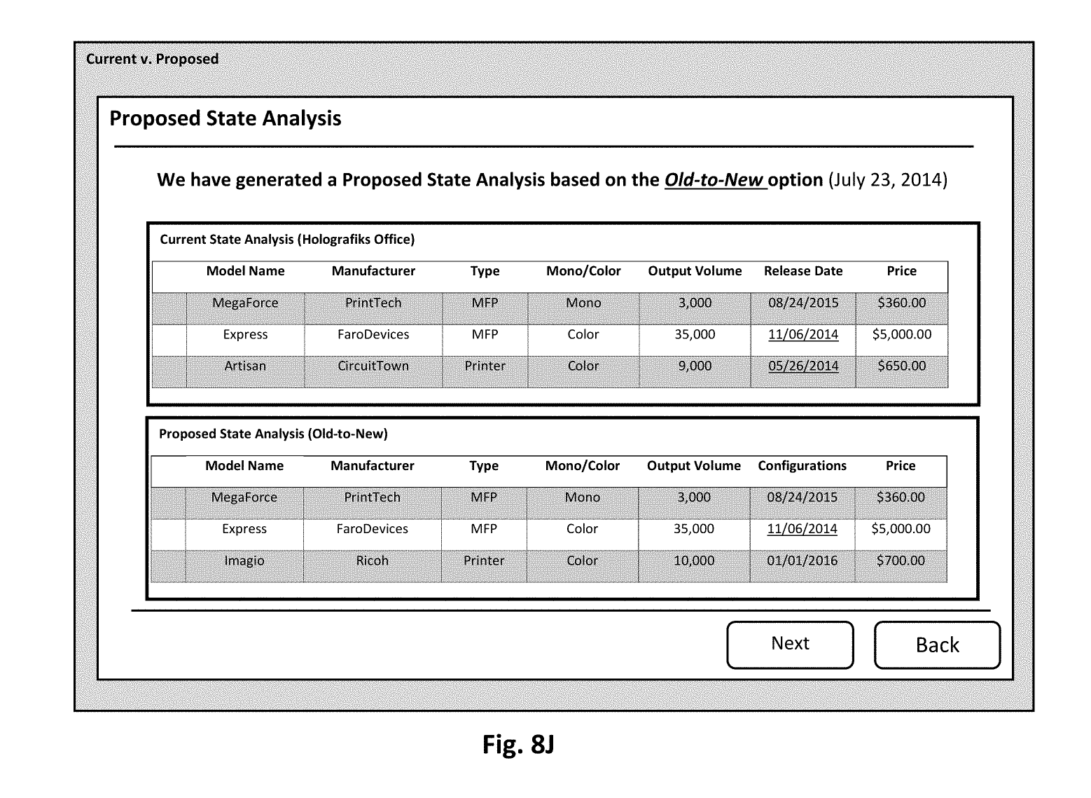

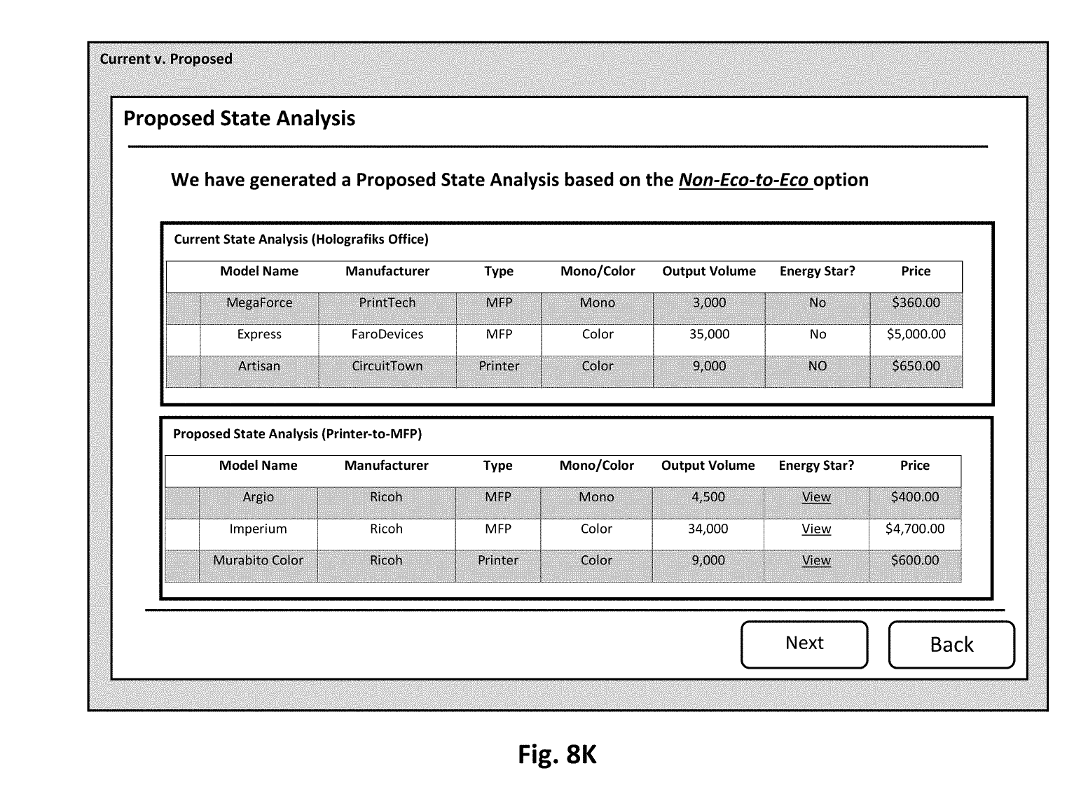

After creating the current state analysis, the user can now create a proposed state analysis by activating the “Basic” button (S700) as previously shown in FIG. 6B. Next, the user is prompted to select a customer (in this case, Vespucci, Inc.) and create a name for the proposed state analysis (in this case, “Holografiks Devices Replacement”), such as shown in FIG. 8A. Subsequently, the user is presented with options to select a current state analysis (e.g., “Site A” and “Site B”), such as shown in FIG. 8B. In this case, since the customer asked the user for a proposed state analysis corresponding to the Holografiks office, the user selects the “Site B” option. After receiving selection of the current state analysis, the device marketing or fleet management application creates a copy of the current state analysis data as a starting point for the proposed state (S701).

Next, the device marketing or fleet management application presents to the user a screen for selecting a method (i.e. automatic or manual) to perform a proposed state analysis, such as shown in FIG. 8C. By selecting the manual option, the user can manually revise the proposed state by adding, removing or editing the devices currently in the proposed state. On other hand, the user can select the automatic option in which the device marketing or fleet management application generates automatically a proposed state analysis (based off the copy of the current state analysis) according to a predetermined criteria.

In this case, the user has selected automatic generation, to have the device marketing or fleet management application automatically generate a proposed state analysis. In response to the user request, the device marketing or fleet management application presents a list of auto-creation options to the user (S702-1), such as shown in FIG. 8D. As stated previously, each of the auto-creation options causes the proposed state to be revised according to a certain criteria specified by the auto-creation option. Such auto-creation options may be created by an administrator and pre-set into the device marketing or fleet management application. Here (FIG. 8D), the auto-creation options are printer-to-MFP, color-to-mono, A3-to-A4, replacement-by-vendor, old-to-new, non-eco-to-eco.

After the user has selected auto-creation options, the device management application determines the target devices that are to be replaced (S702-2), based on target device criteria that are set in the auto-creation options, and then proceed to process the target devices in turn (S703) to determine, for the target device being processed, one or more replacement devices which fulfill (a) replacement criteria that are set in the auto-creation options and (b) matching criteria (e.g., recommended device output volume, mono-color-capability, output type and capability, device type, etc.) corresponding to the auto-creation options.

For example, in the case that the user has selected the printer-to-MFP option, the target device criteria would include all devices that are printers, the replacement criteria would include all devices that are MFPs and the matching criteria would include all replacement devices that have similar recommended device output volume and output type and capability to the target devices. It should be noted that depending on the selection of the auto-creation options by the user, the device marketing or fleet management application may perform similar actions, since, for each of the auto-creation options, there may be two or more auto-creation options that include the same matching criteria.

Next, the device marketing or fleet management application determines whether the user has selected the color-type option (e.g., color-to-mono). In the case that the user has selected the color-type option (S704, yes), the device marketing or fleet management application determines a replacement device that matches the target device based on mono-color-capability, recommended device output volume and device type (S705). Otherwise (S704, no), the device marketing or fleet management application determines whether the user has selected either the environmental-friendly (e.g., non-eco-to-eco) option or the device type (e.g., printer-to-MFP) option (S706). In the case that the user has selected either the environmental-friendly option or the device-type option (S706, yes), the device marketing or fleet management application determines a replacement device that matches the target device based on recommended device output volume and output type and capability (S707). Otherwise (S706, no), the device marketing or fleet management application determines whether the user has selected either the paper-size option (e.g., A3-to-A4), the vendor option (e.g., replacement-by-vendor), or the latest-model (e.g., old-to-new) option (S708). In the case that the user has selected either the paper-size option, the vendor option (S708, yes), or the latest-model option, the device marketing or fleet management application determines a replacement device that matches the target device based on recommended device output volume and device type (S709). After one or more replacements devices have been identified, the device marketing or fleet management application replaces the target device with the identified replacement device(s) (S710).

If there is another target device to be processed (S711, Yes), the application processes such target device for replacement (S703). If there is not another target device to be processed (S711, No), the application proceeds to generate a proposed state analysis (S712).

FIGS. 8E-8K illustrate different scenarios that may occur for each of the auto-creation options that are selected by the user.

In the example illustrated in FIG. 8E, the user has selected the printer-to-MFP option in which devices in the proposed state that are printers are to be replaced with MFPs. As can be seen, the only printer in the proposed state is Artisan (manufactured by CircuitTown). Thus, in the proposed state analysis, Artisan is replaced by Imagio which is an MFP that matches Artisan in terms of recommended device output volume and output type and capability. It should be noted that the replacing device (e.g., Imagio) does not need to have exactly the same features or properties as the target device (e.g., Artisan). It is acceptable that they be close enough. In addition, the user can view the configurations of each of the devices by activating the “view” button.

In the example illustrated in FIG. 8F, the user has selected the color-to-mono option in which devices in the proposed state that include an alternative to print in color are replaced with devices that can only print in a single color (e.g., black-and-white). As can be seen, the only devices in the proposed state that print in color are Express (manufactured by FaroDevices) and Artisan (manufactured by CircuitTown). Thus, in the proposed state analysis, (a) Express is replaced by Regnum which matches Express in terms of recommended device output volume and device type and (b) Artisan is replaced by Regnum which matches Artisan in terms of recommended device output volume and device type.

In the example illustrated in FIG. 8G, the user has selected the A3-to-A4 option in which devices in the proposed state that can print on A3 sized paper are replaced with devices that can print on A4 sized paper. As can be seen, the only device in the proposed state that print in A3 (but not in A4) is MegaForce (manufactured by PrintTech). It should be noted, in one exemplary embodiment, that although Express prints in A3, the reason why Express is not replaced is that it can also print in A4. It should also be noted that, in another exemplary embodiment, while Artisan cannot print in A4, it cannot print in A3 either. Thus, Artisan is not included as a target device to be replaced. Thus, in the proposed state analysis, MegaForce is replaced by Argio which matches MegaForce in terms of mono-color-capability, recommended device output volume and device type. It should be noted that, in yet another exemplary embodiment, the user may be shown the paper size capabilities of each device as opposed to their configurations.

In the example illustrated in FIGS. 8H-1 and 8H-2, the user has selected the replacement-by-vendor option in which devices in the proposed state that are manufactured by one vendor are replaced with devices manufactured by another vendor. As shown in FIG. 8H-1, the user is presented with a user interface screen to select which vendors are to be replaced. The user can add as many vendors as he wants to the list of vendors to be replaced by activating the “Add Vendor” button. Likewise, the user is also presented with options to select a replacement vendor. As such, the user can add as many vendors as he wants to the list of replacement vendors by activating the “Add Replacement Vendor” button. After activating the “Next” button, the user is presented with a proposed state analysis in which all the devices that are not manufactured by Ricoh are replaced by devices that are manufactured by Ricoh. Such Ricoh devices may match the devices to be replaced in terms of mono-color-capability, recommended device output volume, and device type.

In the example illustrated in FIG. 8I and FIG. 8J, the user has selected the old-to-new option in which devices in the proposed state that have a release date on or before a specific date selected by the user are replaced with devices that have release date after the specific date selected by the user. As shown in FIG. 8I, the user is presented with an extra screen to select the specific date. After activating the “Next” button, the user is presented with a proposed state analysis in which all the devices that have a release date before the date specified by the user are replaced by devices that are manufactured by Ricoh and have a release date that is after the date specified by the user. Such Ricoh devices may match the devices to be replaced in terms of mono-color-capability, recommended device output volume, and device type. It should be noted that, in an exemplary embodiment, the user may be shown the release date of each device as opposed to their configurations.

In the example illustrated in FIG. 8K, the user has selected the non-eco-to-eco option in which devices in the proposed state that have not been “Energy Star Certified” by the Environmental Protection Agency (EPA) or the U.S. Department of Energy (DOE) are replaced with devices that are “Energy Star Certified” by the EPA or the DOE. It should be noted that Energy Star Certified may be an international standard for measuring how energy efficient a device is. It should also be noted that the non-eco-to-eco option is not limited to replacing devices that are not Energy Star Certified. There may be other various methods by which to determine whether a device is environmental friendly. As can be seen, none of the devices in the proposed state are Energy Star Certified. Thus, in the proposed state analysis, (a) MegaForce, Express and Artisan are replaced by Argio, Imperium and Murabito Color, respectively. Each of the replacement devices (i.e. Argio, Imperium and Murabito Color) matches each of the replaced devices in terms of recommended device output volume and device type. It should be noted that, in an exemplary embodiment, the user may be shown whether each device is Energy Star Certified as opposed to their configurations.

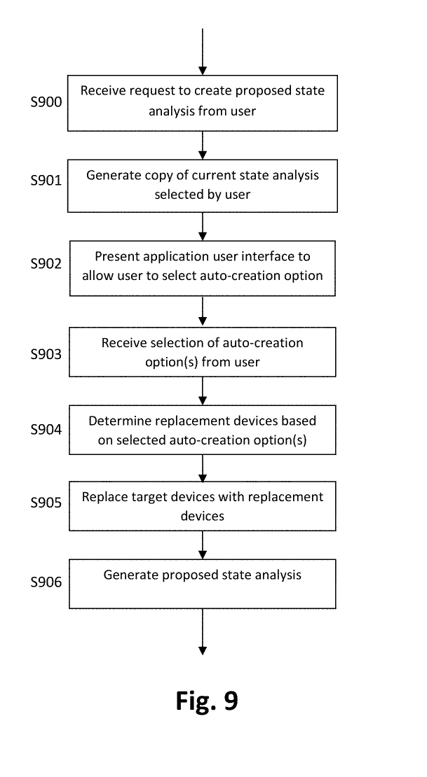

FIG. 9 show a method that can be performed by or with a fleet analysis or device marketing or fleet management application (e.g., 101a) on a terminal apparatus (e.g., 101), according to an exemplary embodiment.

In another exemplary embodiment, after creating the current state analysis, the user can now create a proposed state analysis. After receiving instructions from the user to create a proposed state analysis (S900). Next, the user selects a current state analysis as a basis for the proposed state analysis. After receiving selection of the current state analysis, the device marketing or fleet management application creates a proposed state (S901). Subsequently, the device marketing or fleet management application presents a list of auto-creation options to the user (S902). As stated previously, each of the auto-creation options causes the proposed state to be revised according to a certain criteria specified by the auto-creation option. Such auto-creation options may be created by an administrator and pre-set into the device marketing or fleet management application. In this case, for example, the auto-creation options are printer-to-MFP, color-to-mono, A3-to-A4, replacement-by-vendor, old-to-new, non-eco-to-eco.

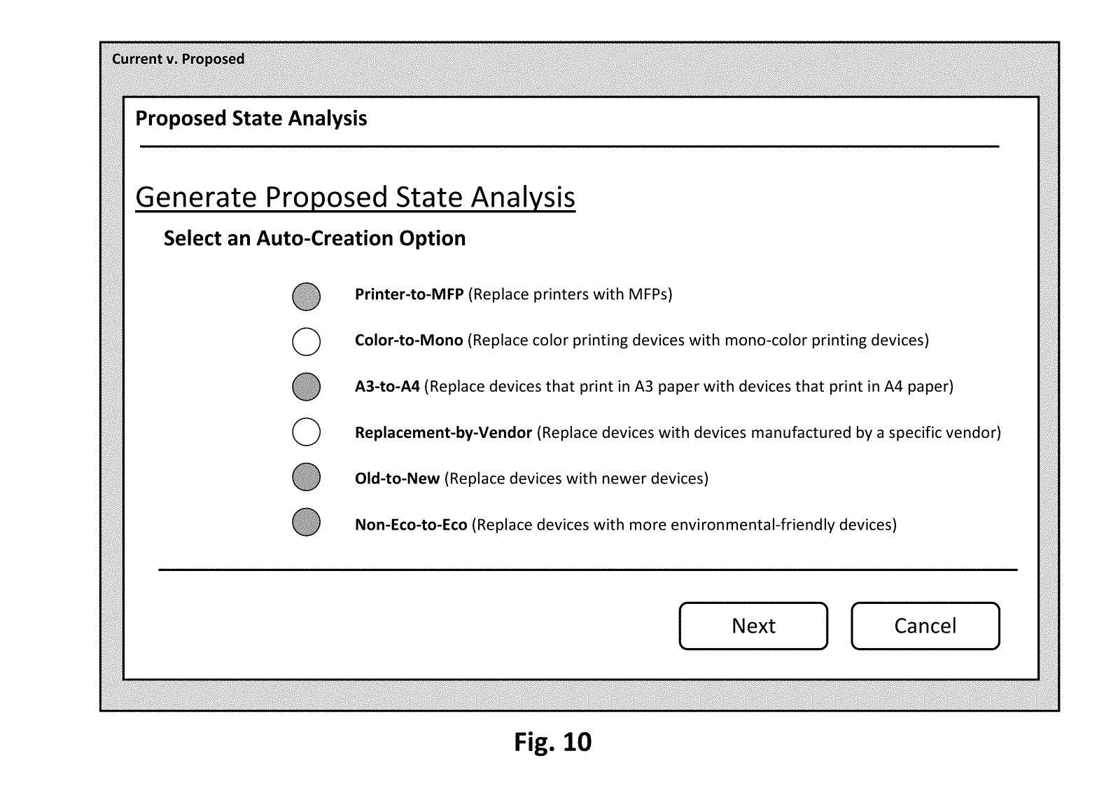

However, the user may select more than one auto-creation option, such as shown in FIG. 10. In other words, the device marketing or fleet management application may generate a proposed state analysis based a combination of one or more auto-creation options. It should be noted that, in an exemplary embodiment, there may be case in which one or more of the auto-creation options contradict each other. Thus, the device marketing or fleet management application may determine priority based on what is set by an administrator (S903).

After the user has selected an auto-creation option, the device management application determines (i) target devices that are to be replaced based on target device criteria that are set in the one or more auto-creation options and (ii) replacement devices which fulfill (a) replacement criteria that are set in the one or more auto-creation options and (b) matching criteria (e.g., recommended device output volume, mono-color-capability, output type and capability, device type, etc.) that are also set in the one or more auto-creation options (S904). After, the replacements devices have been identified (S905), the device marketing or fleet management application replaces the target devices with the identified replacement devices (S906). Finally, the device marketing or fleet management application creates the proposed state analysis.

The orders in which the steps are performed in the aforementioned methods are not limited to those shown in the examples of FIGS. 5, 7 and 9, and may be switched as long as similar results are achieved. Also, it should be noted that the methods illustrated in the examples of FIGS. 5, 7 and 9 may be implemented using any of the systems described in connection with FIGS. 1A and 1B.

The aforementioned specific embodiments are illustrative, and many variations can be introduced on these embodiments without departing from the spirit of the disclosure or from the scope of the appended claims. In addition, elements and/or features of different examples and illustrative embodiments may be combined with each other and/or substituted for each other within the scope of this disclosure and appended claims.

What is claimed is:

1. A device marketing or fleet management application configured to generate a proposed state analysis of a proposed fleet of devices for an enterprise or enterprise site, the device marketing or fleet management application including one or more programs of instructions embodied in a non-transitory computer readable medium and executable by a computer to configure the computer to comprise:
an application user interface (UI) to permit a user to select one or more auto-creation options and to specify a fleet of devices;
a proposed state auto-creation module to apply the user-selected auto-creation options to modify the user-specified fleet of devices and generate a proposed state analysis of the modified fleet of devices.

2. The device marketing or fleet management application as claimed in claim 1, wherein
when the user-selected auto-creation options include printer-to-MFP, the proposed state auto-creation module identifies printer devices amongst the user-specified fleet of devices as replacement targets, and for each replacement target, determine a replacement MFP (multi-function peripheral) device from amongst plural MFP devices registered in a device database, based on matching the replacement MFP device to the replacement target in recommended device output volume and output type and capability, and wherein
the proposed state auto-creation module generates the proposed state analysis of the modified fleet of devices, with the replacement MFP device having replaced the replacement target.

3. The device marketing or fleet management application as claimed in claim 1, wherein
when the user-selected auto-creation options include color-to-mono, the proposed state auto-creation module identifies color printer devices amongst the user-specified fleet of devices as replacement targets, and for each replacement target, determine a replacement mono-only device from amongst plural mono-only devices registered in a device database, based on matching the replacement mono-only device to the replacement target in recommended device output volume and device type, and wherein
the proposed state auto-creation module generates the proposed state analysis of the modified fleet of devices, with the replacement mono-only device having replaced the color replacement target.

4. The device marketing or fleet management application as claimed in claim 1, wherein
when the user-selected auto-creation options include A3-to-A4, the proposed state auto-creation module identifies A3-format devices amongst the user-specified fleet of devices as replacement targets, and for each replacement target, determine a replacement A4-format device from amongst plural A4-format devices registered in a device database, based on matching the replacement A4-format device to the replacement target in mono-color-capability, recommended device output volume and device type, and wherein
the proposed state auto-creation module generates the proposed state analysis of the modified fleet of devices, with the replacement A4-format device having replaced the A3-format replacement target.

5. The device marketing or fleet management application as claimed in claim 1, wherein
when the user-selected auto-creation options include replacement-by-vendor, the proposed state auto-creation module identifies, amongst the user-specified fleet of devices, devices manufactured by a manufacturer other than a specific vendor, as replacement targets, and for each replacement target, determine a replacement device from amongst plural devices registered in a device database and manufactured by the specific vendor, based on matching the replacement device to the replacement target in mono-color-capability, recommended device output volume and device type, and wherein
the proposed state auto-creation module generates the proposed state analysis of the modified fleet of devices, with the replacement device having replaced the replacement target.

6. The device marketing or fleet management application as claimed in claim 1, wherein
when the user-selected auto-creation options include old-to-new, the proposed state auto-creation module identifies, amongst the user-specified fleet of devices, devices having a release date not more recent than a user-specified old device date, as replacement targets, and for each replacement target, determine a replacement device from amongst plural devices registered in a device database that have a release date not older than a user-specified new device date, based on matching the replacement device to the replacement target in mono-color-capability, recommended device output volume and device type, and wherein
the proposed state auto-creation module generates the proposed state analysis of the modified fleet of devices, with the replacement new device having replaced the replacement target.

7. The device marketing or fleet management application as claimed in claim 1, wherein
when the user-selected auto-creation options include non-eco-to-eco, the proposed state auto-creation module identifies non-eco devices amongst the user-specified fleet of devices as replacement targets, and for each replacement target, determine a replacement eco device from amongst plural eco devices registered in a device database, based on matching the replacement eco device to the replacement target in recommended device output volume and device type, and wherein
the proposed state auto-creation module generates the proposed state analysis of the modified fleet of devices, with the replacement eco device having replaced the non-eco replacement target.

8. The device marketing or fleet management application as claimed in claim 1, wherein the auto-creation options provided by the application user interface for user selection includes at least one of:
(a) printer-to-MFP, to replace one or more printer devices with a replacement MFP (multi-function peripheral) device;
(b) color-to-mono, to replace one or more color image forming devices with corresponding replacement mono-only devices;
(c) A3-to-A4, to replace one or more A3-format devices with corresponding replacement A4-format devices;
(d) replacement-by-vendor, to replace one or more devices manufactured by a manufacturer other than a specific vendor, with corresponding replacement devices manufactured by the specific vendor;
(e) old-to-new, to replace one or more devices having a release date not more recent than a user-specified old device date, with corresponding replacement devices that have a release date not older than a user-specified new device date; and
(f) non-eco-to-eco, to replace one or more non-eco devices with corresponding replacement eco devices.

9. The device marketing or fleet management application as claimed in claim 1, wherein
the user-specified fleet of devices is the current fleet of image forming devices in the enterprise or enterprise site and a current state analysis is registered in association with the user-specified fleet of devices, and wherein
the proposed state auto-creation module makes a copy of the current state analysis as a starting state for generating the proposed state analysis.

10. A method performed by a device marketing or fleet management application configured to generate a proposed state analysis of a proposed fleet of devices for an enterprise or enterprise site, the method comprising:
(a) making a copy of a current state analysis for a current fleet of image forming devices in the enterprise or enterprise site;
(b) providing an application user interface (UI) to permit a user to select one or more auto-creation options,
wherein the auto-creation options provided by the application user interface for user selection includes at least one of:
printer-to-MFP, to replace one or more printer devices with corresponding replacement MFP (multi-function peripheral) devices;
color-to-mono, to replace one or more color image forming devices with corresponding replacement mono-only devices;
A3-to-A4, to replace one or more A3-format devices with corresponding replacement A4-format devices;
replacement-by-vendor, to replace one or more devices manufactured by a manufacturer other than a specific vendor, with corresponding replacement devices manufactured by the specific vendor;
old-to-new, to replace one or more devices having a release date not more recent than a user-specified old device date, with corresponding replacement devices that have a release date not older than a user-specified new device date; and
non-eco-to-eco, to replace one or more non-eco devices with corresponding replacement eco devices; and
(c) applying the user-selected auto-creation options to modify the user-specified fleet of devices and generate a proposed state analysis of the modified fleet of devices.

11. The method as claimed in claim 10, further comprising:
when the user-selected auto-creation options include printer-to-MFP, identifying printer devices amongst the user-specified fleet of devices as replacement targets, and for each replacement target, determining a replacement MFP (multi-function peripheral) device from amongst plural MFP devices registered in a device database, based on matching the replacement MFP device to the replacement target in recommended device output volume and output type and capability,
wherein the proposed state analysis of the modified fleet of devices is generated with the replacement MFP device having replaced the replacement target.

12. The method as claimed in claim 10, further comprising:
when the user-selected auto-creation options include color-to-mono, identifying color printer devices amongst the user-specified fleet of devices as replacement targets, and for each replacement target, determining a replacement mono-only device from amongst plural mono-only devices registered in a device database, based on matching the replacement mono-only device to the replacement target in recommended device output volume and device type,
wherein the proposed state analysis of the modified fleet of devices is generated with the replacement mono-only device having replaced the color replacement target.

13. The method as claimed in claim 10, further comprising:
when the user-selected auto-creation options include A3-to-A4, identifying A3-format devices amongst the user-specified fleet of devices as replacement targets, and for each replacement target, determining a replacement A4-format device from amongst plural A4-format devices registered in a device database, based on matching the replacement A4-format device to the replacement target in mono-color-capability, recommended device output volume and device type,
wherein the proposed state analysis of the modified fleet of devices is generated with the replacement A4-format device having replaced the A3-format replacement target.

14. The method as claimed in claim 10, further comprising:
when the user-selected auto-creation options include replacement-by-vendor, identifying, amongst the user-specified fleet of devices, devices manufactured by a manufacturer other than a specific vendor, as replacement targets, and for each replacement target, determining a replacement device from amongst plural devices registered in a device database and manufactured by the specific vendor, based on matching the replacement device to the replacement target in mono-color-capability, recommended device output volume and device type,
wherein the proposed state analysis of the modified fleet of devices is generated with the replacement device having replaced the replacement target.

15. The method as claimed in claim 10, further comprising:
when the user-selected auto-creation options include old-to-new, identifying, amongst the user-specified fleet of devices, devices having a release date not more recent than a user-specified old device date, as replacement targets, and for each replacement target, determining a replacement device from amongst plural devices registered in a device database that have a release date not older than a user-specified new device date, based on matching the replacement device to the replacement target in mono-color-capability, recommended device output volume and device type,
wherein the proposed state analysis of the modified fleet of devices is generated with the replacement new device having replaced the replacement target.

16. The method as claimed in claim 10, further comprising:
when the user-selected auto-creation options include non-eco-to-eco, identifying non-eco devices amongst the user-specified fleet of devices as replacement targets, and for each replacement target, determining a replacement eco device from amongst plural eco devices registered in a device database, based on matching the replacement eco device to the replacement target in recommended device output volume and device type,
wherein the proposed state analysis of the modified fleet of devices is generated with the replacement eco device having replaced the non-eco replacement target.
